(19) United States
(12) Patent Application Publication
(10) Pub. No.: US 2010/0174891 A1
(43) Pub. Date: Jul. 8, 2010

(54) RECONFIGURABLE SIMD PROCESSOR AND METHOD FOR CONTROLLING ITS INSTRUCTION EXECUTION

(76) Inventor: Shohei Nomoto, Tokyo (JP)

Correspondence Address: Mr. Jackson Chen, 6535 N. STATE HWY 161, IRVING, TX, 75039, US

(21) Appl. No.: 12/593,498

(22) PCT Filed: Mar. 27, 2008
(86) PCT No.: PCT/JP2008/055885

§ 371 Date: Sep. 28, 2009

(30) Foreign Application Priority Data
Mar. 29, 2007 (JP) 2007-088656

(51) Int. Cl. G06F 9/302

(52) U.S. Cl. 712/222; 712/221; 712/E09.017

(57) ABSTRACT

In a reconfigurable SIMD processor, a unit of operation for executing an instruction corresponds to one group, and the one group that includes a plurality of PEs implements at least a part of an operation unit that executes at least one of an integer divide instruction: a floating decimal point add/subtract instruction; a floating decimal point multiply instruction; and a floating decimal point divide instruction, using operation units and general purpose registers provided in a plurality of the PEs. The number of the PEs that compose the one group is varied in accordance with the instruction.

The present application is the National Phase of PCT/JP2008/055885, filed Mar. 27, 2008, which claims priority rights based on the Japanese Patent Application 2007-088656 filed in Japan on Mar. 29, 2007. The total disclosure of this patent application of the senior filing date is to be incorporated herein by reference.

### TECHNICAL FIELD

This invention relates to a reconfigurable SIMD processor and, more particularly, to a reconfigurable SIMD processor capable of efficiently implementing a multi-cycle instruction.

### BACKGROUND ART

Recently, with increase in the general feeling of expectation for higher safety and impeccable crime prevention, security cameras are installed in many places, and diversified video processing for images acquired from cameras has begun to be used to avoid car accidents or to manage entrance to or exiting from an office. Since this sort of video processing requires a large amount of computation in a short time, processors for parallel processing, capable of processing a large amount of data at high speed, are currently used.

As one of the parallel processors, a SIMD (Single Instruction Multiple Data) processor, capable of allowing for parallel operations of a large number of processing elements (PEs) based on a single operational instruction, has been developed.

The SIMD processor may exhibit high performance because it allows for parallel operations of larger numbers of PEs. In addition, since larger numbers of PEs can be controlled in common, it is sufficient to generate the sole control information, and hence a smaller number of control circuits suffice to render it possible to reduce the circuit size.

On the other hand, since the SIMD processor includes larger numbers of PEs, the circuit size of the SIMD processor is appreciably increased as the single PE becomes higher in its function and more complex in its configuration. That is, the complexity of the configuration of a PE is in a relationship of trade-off to the number of the PEs.

In actuality, in Non-Patent Document 1, simple processing, such as SAD (Sum of Absolute Difference) is executed at a high speed using larger numbers of simple PEs each composed of a 2-bit ALU (Arithmetic Logic Unit). In Patent Documents 1 and 2, a smaller number of complicated PEs, each provided with a floating decimal point operation unit, is used to implement complicated processing, such as 3DCG.

In Patent Document 3, which is not relevant to a SIMD processor, there is disclosed a CISC processor with an increased operation speed. With this processor, simple instructions, which may be executed in one cycle, are executed in parallel using a plurality of pipelines independently each other. In addition, an instruction of higher function, in need of processing of a large amount of data and complicated processing, is executed using a plurality of pipelines at the same time to expedite the processing.

### Non-Patent Document 1:

M. Nakajima et al., “A 40 GOPS 250 mW Massively Parallel Processor Based on Matrix Architecture”, 2006 IEEE International Solid-State Circuits Conference Digest of Technical Paper step 2006, Feb. 6, pp 1616˜1625

### Patent Document 1:

JP Patent Kokai Publication No. JP2000-148695A

### Patent Document 2:

JP Patent Kokai Publication No. JP2001-256199A

### Patent Document 3:

JP Patent Kokai Publication No. JP-A-6-51984

### SUMMARY

The total of the contents disclosed in the Patent Documents 1 to 3 and the Non-Patent Document 1 is to be incorporated by reference herein. The following gives the analysis of the related arts by the present invention.

In the conventional SIMD processor, the performance and the number of the PEs are fixed. Hence, a problem is presented that subjects for processing having different characteristics may not be coped with flexibly.

For this reason, in the Non-Patent Document 1, 2048 simple PEs, each made up of a 2-bit operation unit, are used to carry out a simple operation. For an operation in need of precision of two or more bits, neighboring multiple PE operation units are used in combination.

However, if simply a plural number of PE operation units are used in combination, the processing performance of the SIMD processor in its entirety may not be improved as desired.

As an example, let it be assumed that sixteen 8-bit addition operations are to be carried out using a processor including 16 PEs each made up of a 2-bit adder.

If 4 PEs are connected to carry out 8-bit addition, since each cycle is able to perform four (=16/4) operations, sixteen 8-bit addition operations can be carried out in four cycles.

On the other hand, 4 cycles are needed to carry out one 8-bit addition in case an individual PE executes carry addition every two bits. However, since sixteen 8-bit addition operations may be carried out simultaneously, sixteen 8-bit addition operations can be carried out in four cycles.

That is, if simply a plurality of operation units of the same sorts of a plurality of PEs are combined together, the SIMD processor on the whole may not be expected to be improved in performance. The range of application of the processor also is limited to, for example, changing the bit widths of the operations. It is thus not possible to flexibly cope with subjects for processing having different characteristics.

In consideration of the above problems, it is an object of the present invention to provide a reconfigurable processor for parallel processing which, in comparison with a SIMD processor including the same number of PEs, is capable of flexibly coping with subjects for processing differing in characteristics with only small increase in resources, thereby enabling the performance to be improved on the whole and a method for controlling the instruction execution of the SIMD processor.

The invention disclosed in the present application may be summarized substantially as follows:

In a processor for parallel operations, according to the present invention, a unit for operation, performing an instruction, composes one group. If one such group is composed of a plurality of processing elements (PEs), the unit of operation of the one group is a unit executing an instruction more complex than a unit of an instruction executable in case one PE composes one group. The processor includes a plurality of PEs (processing elements) capable of performing operations with a number of the PEs as one group. The number of the PEs that compose the one group is changed in accordance with the instruction.

According to the present invention, the information regarding the configuration of the PEs that make up the group is pre-retained in accordance with the instruction. The configuration of the PE is varied in accordance with the instruction, based on the information.

According to the present invention, in case the instruction is a multi-cycle instruction executed by a plurality of PE cycles, the description of the configuration of pipelining registers is provided in the information.

According to the present invention, in case the one group is formed by a single PE, the PE includes a general purpose register that stores the result of PE's operations. In case the one group is formed by a plurality of PEs executing the multi-cycle instruction, the general purpose registers are used as pipelining registers.

According to the present invention, in case the one group is formed by a plurality of PEs executing the multi-cycle instruction, the operation units and the general purpose registers of each of the PEs form at least a part of the operation units and the pipelining registers that execute the multi-cycle instruction.

According to the present invention, in case the multi-cycle instruction is a multi-cycle integer divide instruction, the one group is formed by a plurality of PEs. The first PE in the one group operates as a counter that counts the number of cycles of the multi-cycle integer divide instruction. The second PE in the one group, different from the first PE, is responsive to the counter to subtract a divisor from a dividend of the multi-cycle integer divide instruction a number of times equal to the number of cycles.

According to the present invention, the first PE includes an adder/subtractor and a general purpose register. In executing the multi-cycle integer divide instruction, the first PE stores a cycle count value in the general purpose register of the first PE and updates the count value by the adder/subtractor.

According to the present invention, the second PE includes an adder/subtractor and a general purpose register. In executing the multi-cycle integer divide instruction, the second PE stores a divisor, a dividend and an intermediary division result in the general purpose register. The adder/subtractor subtracts the dividend from the divisor and stores the result of the division in the general purpose register as the intermediary division result.

According to the present invention, in case the multi-cycle instruction is a multi-cycle floating decimal point add/subtract instruction, the one group is made up of a plurality of PEs. The first PE in the one group performs addition/subtraction of a floating decimal point operand, and the second PE in the one group differing from the first PE performs the processing for normalizing the result of the addition/subtraction.

According to the present invention, the first PE includes an adder/subtractor, a differentiator, a barrel shifter and a general purpose register. In executing the multi-cycle floating decimal point add/subtract instruction, the differentiator and the barrel shifter effect the decimal point position registration. The adder/subtractor adds/subtracts the results of the decimal point position registration. The general purpose register is to be a site of temporary storage of the result of the decimal point position registration and the result of the addition/subtraction.

According to the present invention, the first PE includes an adder/subtractor, a differentiator, a barrel shifter, a general purpose register and a normalizing controller. In executing the multi-cycle floating decimal point add/subtract instruction, in the second PE, the adder/subtractor, the differentiator and the barrel shifter normalize the result of addition/subtraction of the first PE under control by the normalizing controller. The general purpose register is to be a site of temporary storage of an intermediary result of the normalization.

According to the present invention, in case the multi-cycle instruction is a floating decimal point multiply instruction, the one group is made up of a plurality of PEs. A first PE in the one group executes processing of multiplication of two floating decimal point operands and part of normalization of the result of multiplication. A second PE in the group different from the first PE operates in cooperation with the first PE to normalize the result of the multiplication.

According to the present invention, the first PE includes a multiplier, a barrel shifter, a leading-one circuit and a general purpose register. In executing the multi-cycle floating decimal point multiply instruction, the multiplier in the first PE multiplies the mantissa parts of operands. The barrel shifter effects part of normalization of result of the multiplication. The general purpose register is to be a site of temporary storage of the result of the multiplication of an intermediary result of the normalization.

According to the present invention, the first PE includes an adder, a barrel shifter, a general purpose register and a normalization controller. In executing the multi-cycle floating decimal point multiply instruction, in the first PE, the adder/subtractor, the barrel shifter and the barrel shifter of the first PE normalize the result of the multiplication under control by the normalization controller. The general-purpose register is to be a site of temporary storage of an intermediary result of the normalization.

According to the present invention, in case the multi-cycle instruction is a multi-cycle floating decimal point divide instruction, the one group is made up of a plurality of PEs. The first PE in the one group performs division of two floating decimal point operands, and the second PE in the one group, different from the first PE, counts the cycles of executing the division and normalizes the result of the division.

According to the present invention, the first PE includes an adder and a general purpose register. In executing the multi-cycle floating decimal point divide instruction, in the first PE, a divisor, a dividend and an intermediary result of division are stored in the general purpose register. The dividend is subtracted by the adder/subtractor from the divisor, and the result of subtraction is stored in the intermediary result of division.

According to the present invention, the second PE includes an adder, a barrel shifter, a general purpose register and a normalization controller. In executing the multi-cycle floating decimal point divide instruction, in the second PE, the cycle count value is stored in the general purpose register, and the counter value is updated by the adder/subtractor. The result of division of the first PE is normalized by the adder and the barrel shifter under control by the normalization controller. The general purpose register is to be a temporary site of storage of an intermediary result of the normalization.

According to the present invention, the operation units of first and second PEs are connected via an inter-PE operation unit connection path 50.

According to the present invention, the first PE includes a control circuit, a general purpose register set, made up of a plurality of PEs, an operation unit set and a data memory. An output of the general purpose register set is selected by a selector (mux1-0) controlled by the control circuit, and is delivered as operands of an instruction for operations to the operation unit set and to the data memory. The operation unit set includes an adder/subtractor, a multiplier and a barrel shifter. The respective operation units of the operation unit set perform operations on the operands delivered from the selector (mux1-0) under control by the control circuit. The result of the operations by the operation unit set is selected by a selector (mux1-1), controlled by the control circuit, so as to be supplied to a selector (mux5). The data memory writes an output of the selector (mux1-0) and data from an external memory data transfer network in memory devices, under control by the control circuit, and data read out from the memory devices are supplied to the selector (mux5) and to the external memory data transfer network. The selector (mux5) selects one of the result of selection of the selector (mux1-1), the read result of the data memory and the contents of the second PE register provided via the inter-PE operation unit connection path, under control by the control circuit. The so selected one is supplied to the general purpose register set.

According to the present invention, the second PE includes a control circuit, a general purpose register set, an operation unit set and a data memory. The operation unit set includes an adder/subtractor, a multiplier and a barrel shifter. An output of the general purpose register set is selected by the selector (mux2-0), controlled by the control circuit, so as to be supplied to the operation unit set and to the data memory. The second PE further includes a second selector (mux0) that selects one of the result of selection of the selector (mux4) and the result of selection of the selector (mux3), under control by the control circuit, to supply the so selected one to the first register of the register set. The second PE further includes a third selector (mux1) that selects one of the selected result of the selector (mux4) and a bit string read out from the second register of the register set from which the LSB (Least Significant Bit) has been removed and to the MSB (Most Significant Bit) of which is added 0. The selector (mux1) supplies the so selected one to the second register. The second PE further includes a fourth selector (mux2) that selects one of the selected result of the sixth selector (mux4) and a bit string read out from the third register of the register set from which the MSB has been removed and to the LSB of which is added the MSB of the result of subtraction of the adder/subtractor. The selector (mux2) supplies the so selected one to the third register.

The operation unit set performs an operation on the operands delivered from the selector (mux2-0) under control by the control circuit. The result of the operation is selected by a selector (mux2-1) controlled by the control circuit and is supplied to the sixth selector (mux4).

The data memory writes an output of the selector (mux2-0) and data from an external memory data transfer network in memory devices and sends data read out from the memory devices to the selector (mux4) and to the external memory data transfer network.

The fifth selector (mux3) selects one of the result of the arithmetic operation of the adder/subtractor and the one operand selected by the selector (mux2-0) under control by the control circuit. The selector (mux3) supplies the so selected one to the selector (mux0).

The sixth elector (mux4) selects one of the result of selection by the seventh selector (mux2-1) and the read result of the data memory, under control by the control circuit, to supply the so selected one to the general purpose register set to update the register set.

According to the present invention, there is provided a method for controlling instruction execution by a processor for parallel operations including a plurality of processing elements (PEs). The number of PEs that share the instruction for execution thereof is varied in dependence upon the instructions executed.

The reconfigurable processor according to the present invention is made up of a plurality of processing elements (PEs) that perform operations as one group, which one group is a unit of instruction execution as a minimum unit executing an instruction more complex than an instruction executable by a single PE. The number of the PEs that go to make up a group is varied depending on the instruction. The processor is thereby able to flexibly cope with subjects for processing of different characteristics to enable the performance to be improved on the whole as resources are suppressed from increasing in volume.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a block diagram showing the global configuration of an exemplary embodiment of the present invention.

FIG. 2 is a block diagram showing a detailed configuration of a PE of the first exemplary embodiment of the present invention.

FIG. 3 is a flowchart for illustrating the operation of the first exemplary embodiment of the present invention.

FIG. 4 is a timing chart showing the operation of the first exemplary embodiment of the present invention.

FIG. 5 is a view showing the single precision bit representation of IEEE754.

FIG. 6 shows an expression for computing the number of single precision floating decimal points of IEEE754.

FIG. 7 is a block diagram showing a detailed configuration of a first PE of a second exemplary embodiment of the present invention.

FIG. 8 is a block diagram showing a detailed configuration of a second PE of a second exemplary embodiment of the present invention.

FIG. 9 is a flowchart for illustrating the operation of the second exemplary embodiment of the present invention.

FIG. 10 is a timing chart for illustrating the operation of the second exemplary embodiment of the present invention.

FIG. 11 is a tabulated view for illustrating the control information generation rule for an adder/subtractor in the second exemplary embodiment of the present invention.

FIG. 12 is a tabulated view for illustrating the plus/minus generation rule for the result of the operations in the second exemplary embodiment of the present invention.

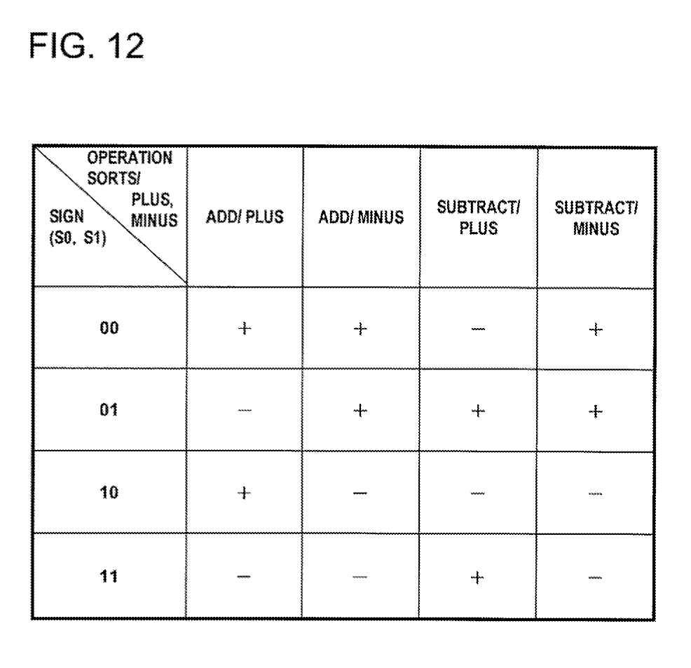

FIG. 13 is a block diagram showing a detailed configuration of a first PE in a third exemplary embodiment of the present invention.

FIG. 14 is a block diagram showing a detailed configuration of a second PE in the third exemplary embodiment of the present invention.

FIG. 15 is a flowchart for illustrating the operation of the third exemplary embodiment of the present invention.

FIG. 16 is a timing chart showing the operation of the third exemplary embodiment of the present invention.

FIG. 17 is a block diagram showing a detailed configuration of a first PE of a fourth exemplary embodiment of the present invention.

FIG. 18 is a block diagram showing a detailed configuration of a second PE of a fourth exemplary embodiment of the present invention.

FIG. 19 is a flowchart for illustrating the operation of the fourth exemplary embodiment of the present invention.

FIG. 20 is a timing chart showing the operation of the fourth exemplary embodiment of the present invention.

### PREFERRED MODES

Certain preferred exemplary embodiments of the present invention will now be described in detail with reference to the drawings.

### Exemplary Embodiment 1

In the exemplary embodiment 1, a reconfigurable SIMD processor in which, when a group is made up of a plurality of PEs, such group executes a multi-cycle integer divide instruction.

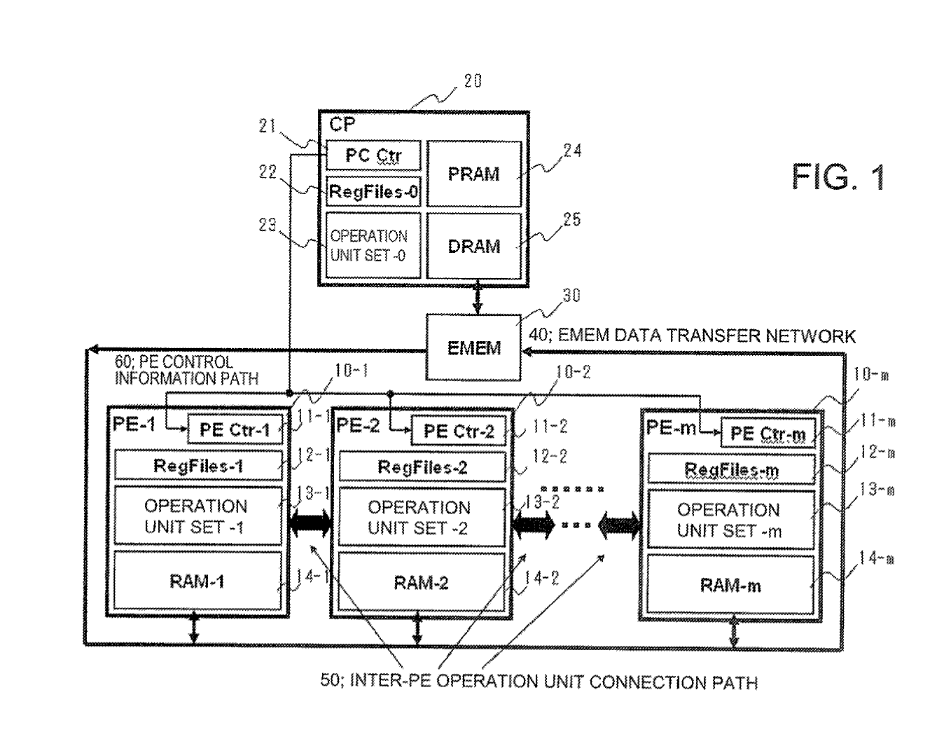

FIG. 1 is a block diagram showing an arrangement of the exemplary embodiment 1 of the present invention. Referring to FIG. 1, the reconfigurable SIMD processor includes processing elements PE-1˜PE-m (10-1˜10-m), a control processor CP (20) which controls PE-1˜PE-m, and an external memory EMEM (30) in which to write data from PE-1˜PE-m and CP and from which to read data to PE-1˜PE-m and CP. EMEM (30) is connected to PE-1˜PE-m via EMEM data transfer network 40, while PE-1˜PE-m are connected over an inter-PE operation unit connection path 50.

The PE-1˜PE-m include controllers PE Ctr-1˜PE Ctr-m (11-1 to 11-m), which controls the operations of the respective PEs, a set of operation unit-1˜a set of operation units-m (13-1 to 13-m), each set of which carries out operations, a set of general purpose registers RegFiles-1˜a set of RegFiles-m (12-1 to 12-m), and internal memories RAM-1 to RAM-m (14-1˜14-m). The general purpose registers supply operands to the set of operation units -1˜the set of operation units -m, while storing the results of the operations of the operation unit sets therein. The internal memories read data from or write data to the RegFiles-1˜RegFiles-m and EMEM.

The control processor CP (20) includes a control information generation circuit PC Ctr(21) that generates an instruction flow for the SIMD processor and the control information for controlling the PE Ctr-1˜PE Ctr-m, a program memory PRAM (24) that stores a program, and a set of operation units-0(23) that execute operations, a set of general purpose registers-0(22) that supply operands to the set of operation units-0 and that store the results of the operations therein, and a data memory DRAM (25) that reads or writes data between it and the RegFiles-0 as well as the EMEM (30).

The control information of PC Ctr(21) of CP(20) is supplied via a PE control information bus 60 to PE Ctr-1˜PE Ctr-m.

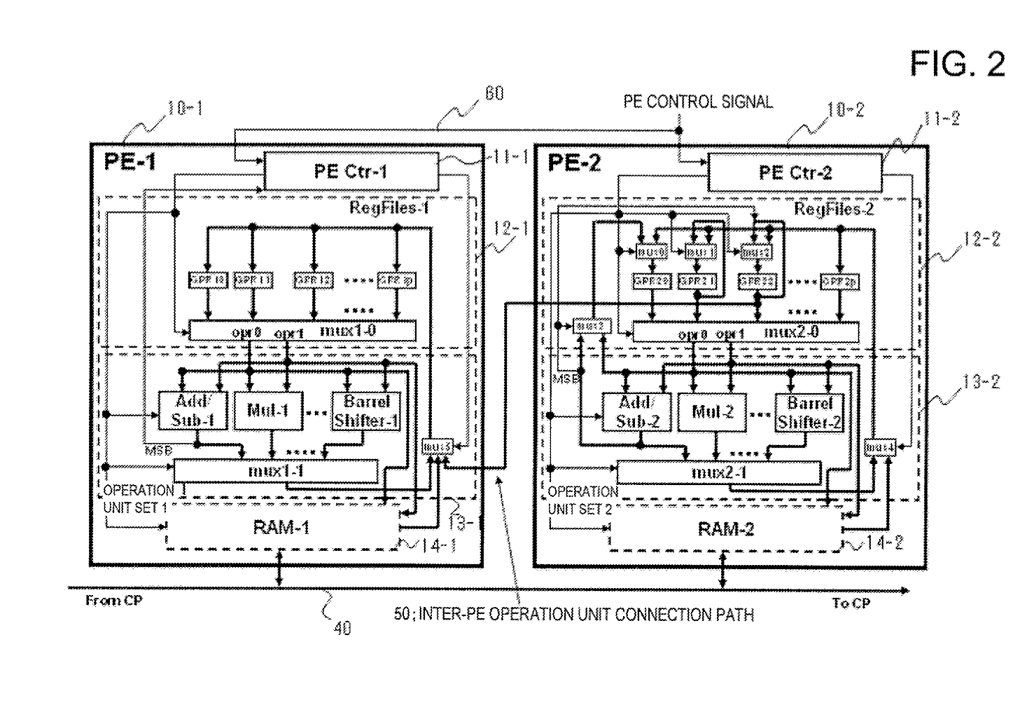

FIG. 2 is a block diagram showing a detailed internal structure of the PE-1 and the PE-2 of FIG. 1. In the present exemplary embodiment, such a case where one group is made up of two PEs in case one such group executes a multi-cycle integer divide instruction, will be described. However, it is as a matter of course that the present invention is not to be limited to this configuration. One group suffices to be made up of two or more PEs.

The roll sharing between PE-1 and PE-2, which will now be described, is only by way of illustration, such that it may be freely changed within the framework of the present invention.

As shown in FIG. 2, the general purpose register set RegFiles-1 of PE-1 includes a plurality of registers GPR 10˜GPR 1p. The registers GPR 10˜GPR 1p are updated by the results of selection by a selector mux5.

A selector mux1-0, controlled by the PE Ctr-1, selects outputs of the general purpose register set, and so selected outputs are delivered as operand (opr0, opr1) to the operation unit set-1 and to RAM-1.

The operation unit set-1 of PE-1 includes an adder/subtractor Add/Sub-1, a multiplier Mul-1 and a barrel shifter Barrel Shifter-1. These operation units perform operations on the operands (opr0, opr1) supplied thereto from the general purpose resister set RegFiles-1 under control by the PR Ctr-1.

The results of the operations are selected by a selector mux1-1 controlled by the PR Ctr-1. The so selected result of the operations is supplied to the selector mux5.

The configuration of the operation unit set-1 of PE-1, shown in FIG. 2, is merely illustrative and may at least be formed by a plurality of operation units performing different sorts of the operations.

The RAM-1 of PE-1 includes a plurality of memory elements, and writes data from the general purpose register set RegFiles-1 and from the EMEM data transfer network in its memory devices.

The data read from the memory devices of the RAM-1 are supplied to the selector mux5 and to an EMEM data transfer network 40.

The selector mux5 selects one of

the result of selection by the selector mux1-1;
the result read from RAM-1; and
a register GPR 22 of PE-2 delivered via the inter-PE operation unit connection path 50, under control by PE Ctr-1. The selector mux5 supplies the so selected one to the general purpose register set RegFiles-1.

A general purpose register set RegFiles-2 of PE-2 includes a plurality of registers GPR 20˜GPR 2p. The registers GPR 20, GPR 21 and GPR 22 are updated by the results of selection by the selectors (mux0, mux1, mux2), while GPR 23˜GPR 2P are updated by the results of selection by the selector mux4. Outputs of the registers are selected by the selector mux2-0, controlled by the PE Ctr-2, so as to be supplied as operands (Opr0, Opr1) to the operation unit set -2 and to RAM -2.

Based on control by PE Ctr-2, the selector mux0 selects the result of selection of the selector mux4 or that of the selector mux3 to supply the so selected result to the GPR 20.

Based on control by PE Ctr-2, the selector mux1 selects one of the result of selection by the selector mux4 and a bit string which has been read from the GPR 21 and got rid of the LSB (Least Significant Bit) and to the MSB (Most Significant Bit) of which is added 0 and provides the so selected one to the GPR 21.

Based on control by PE Ctr-2, the selector mux2 selects one of the result of selection by the selector mux4 and a bit string which has been read from the register GPR 21 and got rid of the MSB (Most Significant Bit) and to the LSB (Least Significant Bit) of which the MSB of the result of the subtraction of Add/Sun-2 is added. The selector mux2 provides the so selected one to the GPR 22. An output of the GPR 22 is supplied via the inter-PE operation unit connection path 50 to the selector mux5 of the PE-1.

An operation unit set -2 of PE-2 includes an adder/subtractor Add/Sub-2, a multiplier Mul-2 and a barrel shifter Barrel Shifter-2. These operation units perform operations on the operands supplied thereto from the general purpose resister set RegFiles-2, under control by the PE Ctr-2.

The results of the operations are selected by a selector mux2-1 controlled by the PR Ctr-2. The so selected result of the operations is supplied to the selector mux4.

The configuration of the operation unit set-2 of PE-2, shown in FIG. 2, is merely illustrative and may at least be configured y a plurality of operation units performing different sorts of the operations.

The RAM-2 of PE-2 includes a plurality of memory devices. The RAM-2 of PE-2 writes data from the set of general purpose registers RegFiles-1 and the EMEM data transfer network 40 in the memory devices, or provides the data read from the memory devices to the selector mux4 and to the EMEM data transfer network 40, under control by the PE Ctr-1.

The selector mux3 selects the result of the operation by the adder/subtractor Add/Sub-2 and one opr0 of the operands, selected by the selector mux2-0, to supply the result of the operations and the operand opr0, thus selected, to the selector mux0.

The selector mux4 selects one of the result of selection by the selector mux2-1 and the result read from RAM-2, under control by the PE Ctr-2, and supplies the so selected one to the general purpose register set RegFiles-2.

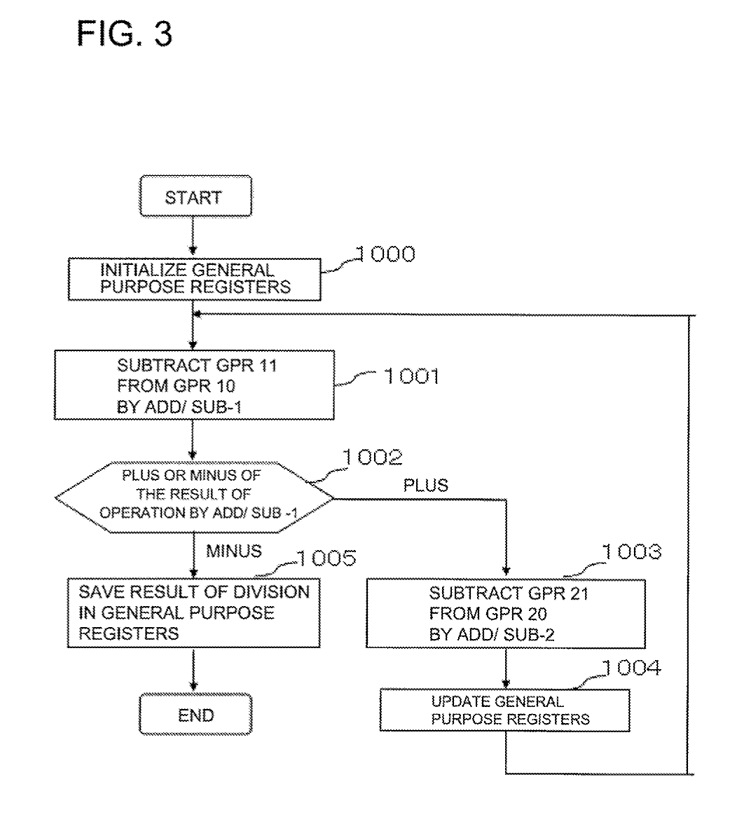

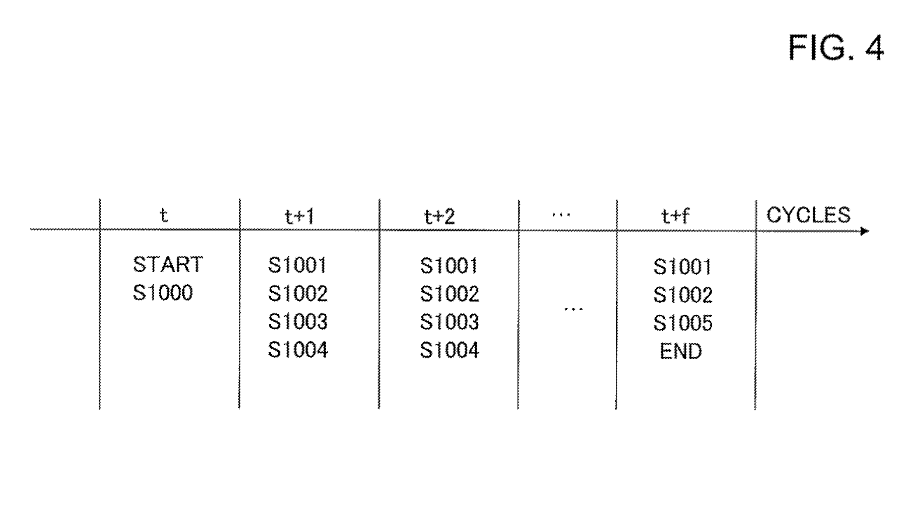

FIG. 3 is a flowchart showing an example processing sequence of a reconfigurable SIMD processor, shown in FIGS. 1 and 2, in which, when one group is formed by a plurality of PEs, such group executes a multi-cycle integer divide instruction. FIG. 4 is a timing chart showing the timings of execution of respective steps of FIG. 3. Referring to FIGS. 2 to 4, the method of processing by the reconfigurable SIMD processor that executes the multi-cycle integer divide instruction will be described in detail.

Initially, PE-1 initializes GPR 11 to the number of cycles needed for division of GPR 10, while initializing GPR 11 to 1. The PE-2 initializes GPR 20 to a dividend, while initializing GPR 22 to 0 (step 1000).

The step S1000 is executed with the first cycle t.

In the step S1000, the registers to be initialized are GPR 10, GPR11, GPR 21 and GPR 22. However, the present invention is not limited to this configuration such that any optional registers may be subjects of the initialization.

Then, under control by the PE Ctr-1, GPR 10 and GPR 11 are selected as the operands (opr0, opr1) of the operation, and opr1 is subtracted from opr0 by the Add/Sub-1 (step 1001).

Here, the value 1 of opr1 is provided as a register value (GPR 11). However, the value 1 need not necessarily be the register value and may also be provided by other means, such as an immediate value.

If the result of the operation is positive, a step 1003 is executed and, if the result of the operation is negative, a step 1005 is executed. The positive and negative results of the operations are notified to Ctr-1 (step 1002).

Here, the number of times of the count operations is set in GPR 10, while 1 is set in GPR 11, and GPR 11 is subtracted from GPR 10. The number of cycles of execution of the multi-cycle integer divide instruction is counted based on the positive or negative value of the result of the subtraction.

However, the manner of counting the number of cycles is not limited to this configuration. For example, it is as a matter of course possible to use such a technique of adding 1 to an initial value 0 and to compare the result to the number of cycles needed.

If the result of the operation is positive, PE-2 selects GPR 20 and GPR 21 as the operands (opr0, opr1) for the operations, by the selector mux2-0, under control by PE Ctr-2, and opr1 is subtracted from opr0 by the adder/subtractor Add/Sub-2 (step 1003).

Then, in PE-1, the selectors mux1-1 and mux5 select the result of the operation by the adder/subtractor Add/Sub-1, under control by the PE Ctr-1. The GPR 10 is updated by the result of the selection (step 1004).

In PE-2, the selector mux3 is controlled by the positive or negative value of the result of the operation by the adder/subtractor Add/Sub-2. If the result of the operation is positive, PE-2 selects the result of the operation and, if the result of the operation is negative, PE-2 selects opr0.

The result of the selection by mux3 is selected by the selector mux0, under control by the PE Ctr-2, and the GPR 20 is updated with the result of the selection (step 1004).

Also, under control by the PE Ctr-2, the selector mux1 selects a bit string which has been read from the GPR 21 and got rid of the LSB (Least Significant Bit) and to the MSB (Most Significant Bit) of which is added 0. The selector mux1 updates the GPR 21 with the so selected value (step 1004).

Further, under control by PE Ctr-2, the selector mux2 selects a bit string which has been read from the GPR 22 and got rid of the MSB (Most Significant Bit) and to the LSB (Most Significant Bit) of which is added a value obtained by inverting the MSB of the result of the subtraction by ADD/Sub-2. The selector mux1 updates the GPR 22 with the so selected value (step 1004).

On the other hand, if the result of the operation by the adder/subtractor Add/Sub-1 is negative, PE-2 sends the value of GPR 22, the result of the integer division, via the inter-PE operation unit connection path 50 to PE-1. The selector mux5 in PE-1 selects the result of integer division, under control by PE Ctr-1, which has been notified of the fact that the number of cycles of the division operation has reached a predetermined value. The so selected result of the integer division is written in an optional register within the general purpose register RegFiles-1 (step 1005).

Referring to FIG. 4, the steps 1001˜1004 are executed in the same cycle. If the result of the operation by the adder/subtractor Add/Sub-1 is positive, these steps are executed reiteratively. If the result of the operation by the adder/subtractor Add/Sub-1 is negative, the steps 1001˜1005 are executed to terminate execution of the multi-cycle integer divide instruction.

Thus, with the present exemplary embodiment, in which the multiple selectors (mux0˜mux3) are added and the control circuits for the selector mux5 and the PE Ctr-1, PE Ctr-2 are extended, it is possible to implement a multi-cycle integer divide instruction.

Since it is unnecessary to newly add registers or operation units of larger circuit size, the multi-cycle integer divide instruction can be implemented by only slight increase in the circuit size.

On the other hand, if the integer divide instruction is to be executed by an instruction combination that may be dealt with by a single PE, cycle control, subtraction of the divisor from the dividend and bit operations of the result of the operations need to be sequentially implemented by a pre-existing instruction. Hence, about 10 cycles are needed to compute one digit of the result of the division.

With the present exemplary embodiment, one digit of the result of division can be computed by one cycle, despite the fact that the number of instructions of the integer division is halved. Hence, the performance of the SIMD processor in its entirety may be improved by a factor of about five in comparison with the case of implementing the integer division by a single PE.

### Exemplary Embodiment 2

In the exemplary embodiment 2 of the present invention, a reconfigurable SIMD processor in which, when one group is constituted by a plurality of PEs, such group executes the multi-cycle floating decimal point add/subtract instruction, is described in detail. Here, single precision of IEEE754 is used as a form of expressing the number of floating decimal points.

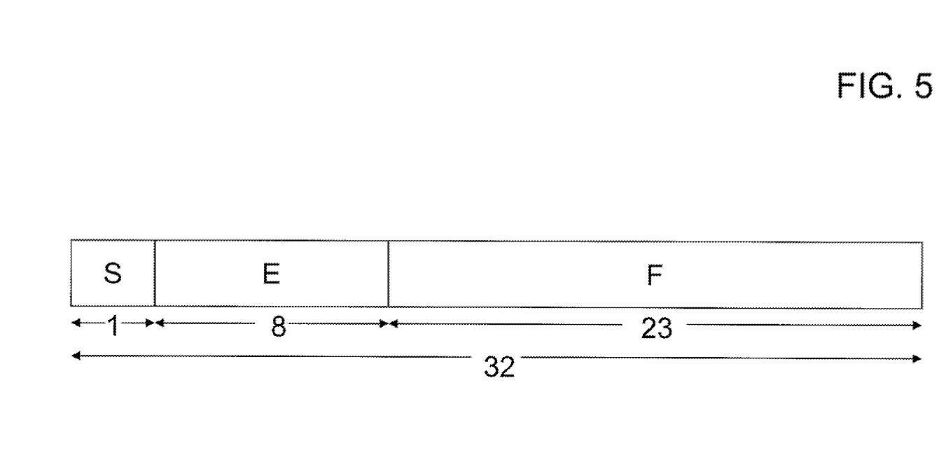

FIG. 5 shows single precision bit arrangement by IEEE754. Referring to FIG. 5, the single precision of IEEE754 is formed by a bit string of 32 bits, and is divided into a sign part (S), an exponent part (E) and a mantissa part (F).

A real number is represented by a ±[sign part]1. [mantissa part]×2̂[exponent part]. In the following explanation, it is assumed that the sign part, exponent part and the mantissa part of the operands 0 and 1, as subjects of the operations, are S0 and S1, E0 and E1, and F0 and F1, respectively. Although the IEEE754 single precision is used as the form for representing the floating decimal point numbers, it is of course possible to use other representation forms.

The configuration of the SIMD processor in its entirety of the exemplary embodiment 2 of the present invention is similar to the exemplary embodiment 1 shown in FIG. 1. Hence, explanation of the exemplary embodiment 2 with reference to FIG. 1 is dispensed with.

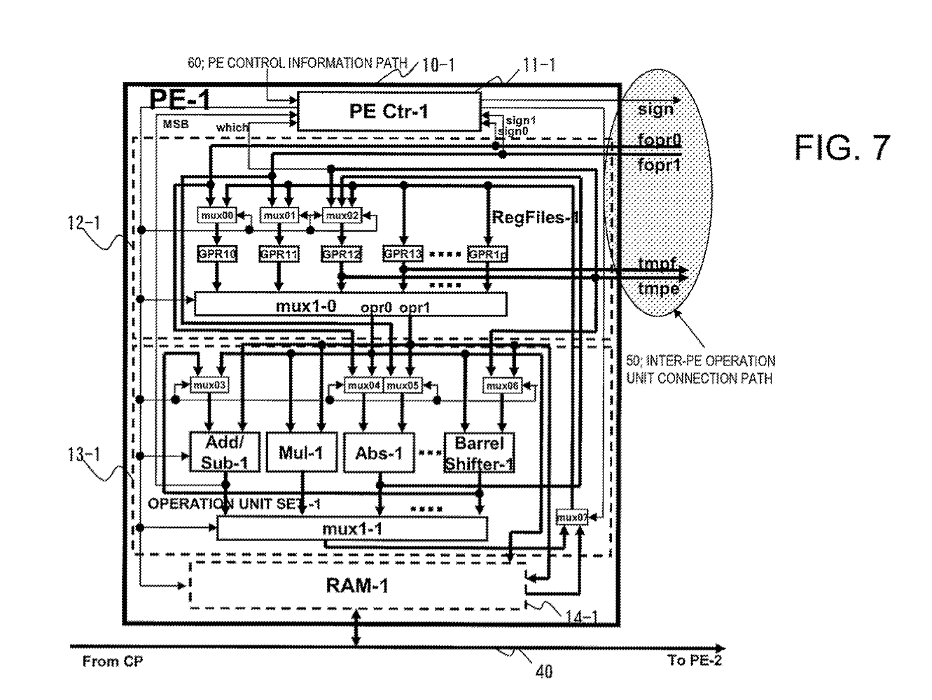

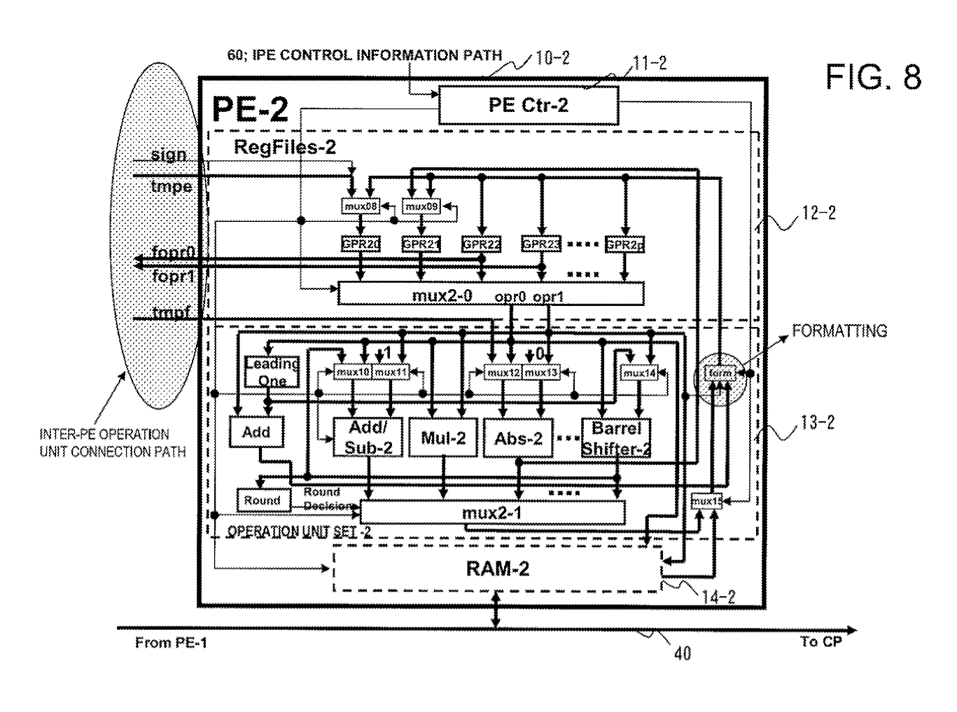

FIGS. 7 and 8 are block diagrams showing the detailed internal configurations of PE-1 and PE-2 of FIG. 1, respectively. In the present exemplary embodiment, such a case in which, if one group executes a multi-cycle floating add-subtract instruction, the group is made up by two or more PEs. With the present invention, it is sufficient that one group includes two or more PEs. The role sharing by PE-1 and PE-2 as now described is merely illustrative and that the present invention is not to be limited to such configuration.

Referring to FIGS. 7 and 8, the PE-1 receives from the PE-2 fopr0, fopr1, which are operands of the floating decimal point add/subtract instruction, via the inter-PE operation unit connection path 50. The PE-1 then provides the PE-2 with an intermediary result of the mantissa part tmpf, an intermediary result of the exponent part tmpe and an intermediary sign result (sign). The following description is directed to PE-1, with reference being made to FIG. 7.

The general purpose register set RegFiles-1 of PE-1 includes a plurality of registers GPR 10˜GPR 1p. The GPR 10, GPR 11 and the GPR 12 are updated by the result of selection by the selectors (mux00, mux01 and mux02), respectively, and the GPR 13˜GPR 1p are updated by the result of selection by the selector mux07.

The register outputs are selected by the selector mux1-0, controlled by the PE Ctr-1, and are supplied as operands (opr0, opr1) to the operation unit set-1 and to the RAM-1.

The selector mux00 selects one of fopr1 supplied from PE-2 via the inter-PE operation unit connection path 50, and the result of selection by the selector mux07, under control by PE Ctr-1, and provides the so selected one to the GPR 10.

The selector mux01 selects one of fopr1, supplied from PE-2 via the inter-PE operation unit connection path 50, and the result of selection of the selector mux07, provided from PE-2, under control by PE Ctr-1, to supply the so selected one to GPR 11.

The selector mux02 selects one of a bit string and the result of selection by the selector mux07, under control by PE Ctr-1, to supply the so selected one to GPR 12. The bit string has its lower and upper parts formed respectively by a lower order half of the result of the arithmetic operation by a differentiator Abs-1 of the operation unit set-1 and by a lower order half of the GPR.

The operation unit set-1 of PE-1 includes

an adder/subtractor Add/Sub-1;

a multiplier Mul-1;

a differentiator Abs-1; and

a barrel shifter Barrel Shifter-1.

The adder/subtractor Add/Sub-1 performs an arithmetic operation, under control by the PE Ctr-1, with the result of selection of the selector mux03 and opr1 as operands.

The multiplier Mul-1 performs an operation, under control by the PE Ctr-1, on the opr0 and opr1 as operands.

The differentiator Abs-1 performs an arithmetic operation, under control by the PE Ctr-1, on the results of selection of the selectors mux04 and mux05 as operands.

The barrel shifter Barrel Shifter-1 performs an operation, under control by the PE Ctr-1, on the opr0 and the result of selection by the selector mux06 as operands.

The results of the operations are selected by the selector mux1-1, controlled by the PE Ctr-1, and are provided to the selector mux07.

The selector mux03 selects one of the result of the operation by the barrel shifter Barrel Shifter-1 and the operand opr0, under control by the PE Ctr-1, and provides the so selected one to the adder/subtractor Add/Sub-1.

The selector mux04 selects one of opr0 and an exponent part E0 of fopr1, provided from the PE-2, under control by the PE Ctr-1, and provides the so selected one to the differentiator Abs-1.

The selector mux05 selects one of the exponent part E1 of fopr1, provided from the PE-2 via the inter-PE operation unit connection path 50, or the operand opr1, under control by the PE Ctr-1, and provides the so selected one to the differentiator Abs-1.

The selector mux06 selects one of a bit string and opr1, under control by the PE Ctr-1, and provides the so selected one to the barrel shifter Barrel Shifter-1. The bit string includes a lower order half of GPR 12 and zeros combined in its upper half.

The RAM-1 of the PE-1 is formed by memory devices in which to write data from the general purpose register set RegFiles-1 and data from the EMEM data transfer network 40 under control by the PR Ctr-1. Or, data read from the memory devices are supplied to the selector mux07 and to the EMEM data transfer network 40.

The selector mux07 selects the result of selection of the selector mux1-1 or the result read from the RAM-1 and provides the result of selection to the general purpose register set RegFiles-1

Referring to FIG. 8, the PE-2 receives from the PE-1 an intermediary result of the mantissa part tmpf, an intermediary result of the exponent part tmpe and an intermediary sign result (sign), which are intermediary results of the floating decimal point add/subtract instruction. The PE-2 provides fopr0, fopr1, which are operands of the floating decimal point add/subtract instruction, to the PE-1.

Referring to FIG. 8, the general purpose register set RegFiles-2 of the PE-2 includes a plurality of registers GPR 20˜GPR 2p. The GPR 20 and GPR 21 are updated by the result of selection by the selectors (mux08, mux09), respectively, and the GPR 22˜GPR 2p are updated by the result of selection by the formatting unit (form). The outputs of the above registers are selected by the selector mux2-0, controlled by the PE Ctr-2, so as to be supplied as operands (opr0, opr1) to the operation unit-2 and to the RAM-2.

The selector mux08 selects one of a bit string and the result of selection by the selector mux15, under control by the PE Ctr-2, via the inter-PE operation unit connection path 5, and provides the so selected one to the GPR 20. The bit string has its lower order part formed by the intermediary exponent part result tmpe, supplied from PE-2, while having an intermediary sign result (sign) as its upper order bit.

The selector mux09 selects one of the result of the operation by the differentiator Abs-2 of the operation unit set-2 and the result of selection of the selector mux15, under control by the PE Ctr-2. The selector mux09 provides the so selected one to the GPR 21.

The operation unit set-2 of the PE-2 includes an adder/subtractor Add/Sub-2, a multiplier Mul-2, a differentiator Abs-2 and a barrel shifter Barrel Shifter-2.

The adder/subtractor Add/Sub-2 performs an operation on the results of selection by the selectors mux10 and mux11, as operands, under control by the PE Ctr-2.

The multiplier Mul-2 performs an operation on opr0 and opr1, as operands, under control by the PE Ctr-2.

The differentiator Abs-2 performs an operation on the results of selection by the selector mux12 and the selector mux13 as operands, under control by the PE Ctr-2.

The barrel shifter Barrel Shifter-2 performs an operation on opr0 and the result of selection by the selector mux14, as operands, under control by the PE Ctr-2.

The result of the operation is selected by the selector mux2-1 controlled by the PE Ctr-2. The so selected result is supplied to the selector mux15.

The selector mux10 selects one of the result of the operation by the barrel shifter Barrel Shifter-2 and opr0, under control by the PE Ctr-2, and provides the so selected one to the adder/subtractor Add/Sub-2.

The selector mux11 selects one of the value 1 and opr1, under control by the PE Ctr2, under control by the PE Ctr-2, and provides the so selected one to the adder/subtractor Add/Sub-2.

The selector mux12 select one of the intermediary result of the mantissa part tmpf, supplied from the PE-1, under control by the PE Ctr-2, via the inter-PE operation unit connection path 50, and opr0, and provides the so selected one to the differentiator Abs-1.

The selector mux13 selects one of the value 0 and opr1, under control by the PE Ctr-2, and provides the so selected one to the differentiator Abs-2.

The selector mux14 selects one of the result of the operation of a leading-one Leading-One and opr1, under control by the PE Ctr-2, and provides the so selected one to the barrel shifter Barrel Shifter-2.

The operation unit set-2 of the PE-2 includes a leading-one Leading-One, an adder ADD and a rounding detection unit Round, used exclusively for executing the floating decimal point add/subtract instruction.

The leading-one Leading-One retrieves the bit string of the operand opr0 from the MSB side and calculates the distance from the MSB to the first appearing 1, and provides the so calculated distance to the adder Add and to the selector mux14.

The adder Add sums a partial bit stream of opr1 to the retrieved result of the leading-one Leading-One to supply the resulting sum to the formatting unit (form).

The rounding detection unit Round decides whether or not the result of the operation of the barrel shifter Barrel Shifter-2 is in need of rounding, and provides the so verified result to the selector mux2-1.

The RAM-2 of the PE-2 includes memory devices, not shown, and writes data from the set of general purpose registers RegFiles-2 and from the EMEM data transfer network in the memory devices under control by the PE Ctr-2. Or, the RAM-2 provides data read from the memory devices to the selector mux15 and to the EMEM data transfer network 40.

The selector mux15 selects the read result of the selector mux2-1 or the read result from the RAM-2, under control by the PE Ctr-2, and provides the so selected result to the formatting unit (form).

The formatting unit (form) selects the result of selection by the selector mux15 as a mantissa part, while selecting the result of the operation of the adder Add as an exponent part and selecting the result of the sign as a sign part, under control by the PE Ctr-2. The formatting unit sets the format to the form of single precision of IEEE754, and provides the result to the general purpose register set RegFiles-2.

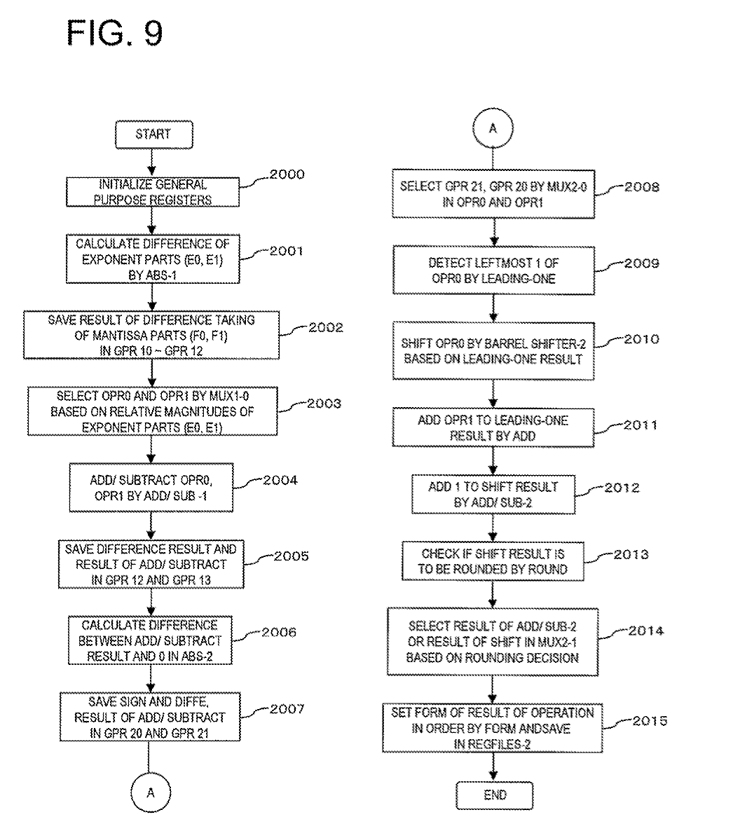

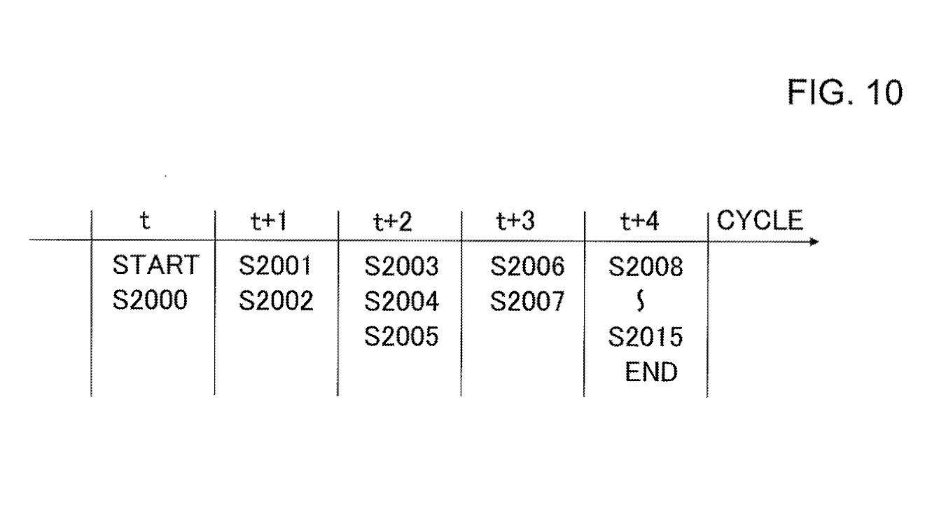

FIG. 9 is a flowchart showing the operation of the reconfigurable SIMD processor of the exemplary embodiment 2, shown in FIGS. 1, 7 and 8, in which, when one group is formed by a plurality of PEs, such group executes the multi-cycle floating decimal point add/subtract instruction. FIG. 10 is a timing chart showing the timing of execution of respective steps of FIG. 9. In the following, the reconfigurable SIMD processing method for executing a multi-cycle floating decimal point add/subtract instruction is explained in detail with reference to FIGS. 9 and 10.

First, in the PE-2, the GPR 20 is initialized to the operand 0 (fopr0) of the floating decimal point, while the GPR 21 is initialized by the operand 1 (forp1) of the floating decimal point (step 2000). The step 2000 is executed at a first cycle t, as shown in FIG. 10.

In the step 2000, the GPR 20 and GPR 21 are registers to be initialized. However, the present invention is not limited to this configuration and may have an optional register as an object for initialization. The operands of the floating decimal points may be specified by immediate values or by a combination of two or more registers.

The floating decimal point operands (fopr0, fopr1), stored in the GPR 20 and in the GPR 21, are supplied via the inter-PE operation unit connection path 50 to PE-1. In the PE-1, the exponent parts (E0, E1) of the operands (fopr0, fopr1) are selected by the selectors mux04 and mux05, and the difference between the exponent parts E0 and E1 is calculated by the differentiator Abs-1 (step 2001).

The selector mux00 in the PE-1 selects one of a mantissa part (F0) of fopr0 and a bit string corresponding to the F0 to the MSB side of which is added 1, and updates the GPR 10 by the so selected one (step 2002).

The selector mux01 selects one of a mantissa part (F1) of fopr1 and a bit string corresponding to the mantissa part (F1) of fopr1, to the MSB side of which is added 1, and updates the GPR 11 by the so selected bit string (step 2002).

The selector mux02 selects lower 8 bits of the result of the operation of the differentiator Abs-1, and updates the lower 8 bits of the GPR 12 by the result of the selection (step 2002).

In the step 2002, the relative magnitudes of the exponent parts (E0, E1), and the sign parts (S0, S1) of fopr0 and fopr1, are saved in a register, not shown, newly provided in a PE Ctr-1.

The steps 2001 and 2002 are executed by the second cycle t+1, as shown in FIG. 10.

If the relative magnitudes of the exponent parts (E0, E1), saved in the PE Ctr-1, are such that

E0>E1

the GRP 10 and the GRP 11 are selected as opr0 and opr1, respectively, by the selector mux1-0, under control by the selector PE Ctr-1 (step 2003).

If E0<E1, the GRP 11 and the GRP 10 are selected as opr0 and opr1, respectively, by the selector mux1-0, under control by the PE Ctr-1. The result of the selection is supplied to the general purpose register set-1 (step 2003).

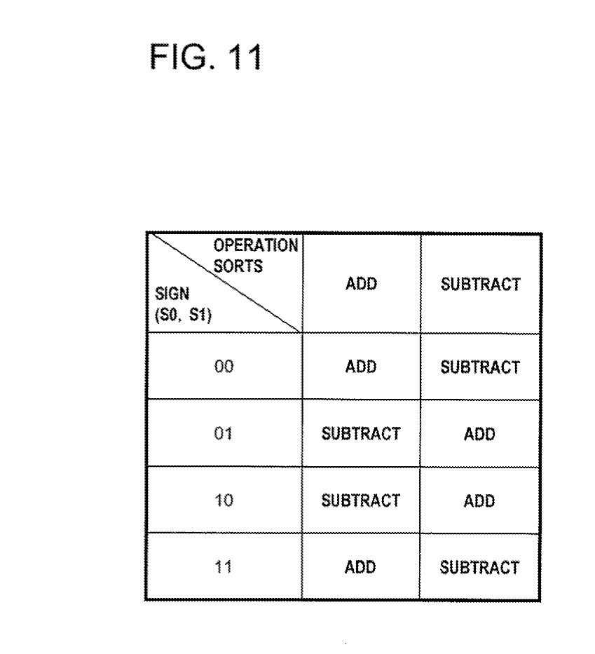

Referring to FIG. 11, the adder/subtractor Add/Sub-1 PE Ctr-1 is controlled by the PE Ctr-1 so as to perform addition or subtraction on opr0 and opr1, based on the sign parts (S0, S1) saved in the PE Ctr-1 and on the information as to which of addition and subtraction is to be performed by the adder/subtractor Add/Sub-1.

The selector mux02 selects, under control by the PE Ctr-1, the result of the difference of the exponent part saved in the lower eight bits of the GPR 12, and updates the upper eight bits of the GPR 12 by the result of the selection (step 2005).

Also, in the step 2005, the PE Ctr-1 decides on the sign of the result of the operations of the floating decimal point addition/subtraction, based on whether the result of the operation of the adder/subtractor Add/Sub-1 is positive or negative and on the sign parts (S0, S1) saved in the PE Ctr-1. The PE Ctr-1 causes the sign to be stored in a register, not shown, newly provided in the PE Ctr-1.

In addition, the selector mux1-1 selects the result of the operation of the adder/subtractor Add/Sub-1, under control by the PE Ctr-1, and sends the result of the selection to the selector mux0-7.

The selector mux0-7 selects the result of the selection of the selector mux1-1, under control by the PE Ctr-1, and updates the GPR 13 by the result of the selection (step 2005).

The steps 2003 to 2005 are executed at the third cycle t+2, as shown in FIG. 10.

The PE-1 provides

a difference tmpe of the exponent parts stored in the upper eight bits of the GPR 12,

a result of addition/subtraction of the mantissa parts stored in the GPR 13, and

a sign of the result of the operation (sign)

to the PE-2 via the inter-PE operation unit connection path 50. In addition, the selector mux12 selects tmpf, the selector mux13 selects 0 and the differentiator Abs-2 calculates the difference between the results of the selection (step 2006).

In the PE-2, the selector mux08 selects, under control by the PE CTr-2, a bit line corresponding to a sign result (sign) added to the upper bit side of the intermediary result of the mantissa part tmpe provided by the PE-1. The selector mux09 also selects the result of the operation of the differentiator Abs-2. The respective results of the selection are stored in the GPR 20 and in the GPR 21 (step 2007).

The steps 2006 and 2007 are executed at the fourth cycle t+3, as shown in FIG. 10.

Under control by the PE Ctr-2, the selector mux2-0 selects the GPR 21 as opr0, while selecting the GPR 20 as opr1 (step 2008).

The Leading-One then scans the bit string of opr0 from the MSB to the LSB side thereof to count the number of bits encountered during the scanning from the MSB to the first occurrence of 1 (step 2009).

Under control by the PE Ctr-2, the selector mux14 selects the result of the operations of the Leading-One, while the Barrel Shifter-2 shifts bits of opr0 based on the result of selection (step 2010).

The adder Add adds the intermediary result of the exponent part tmpe and the result of the operation of the Leading-One together (step 2011).

Under control by the PE Ctr-2, the selector mux10 selects the result of the operation of the barrel shifter Barrel Shifter-2, while the selector mux11 selects 1. The adder/subtractor Add/Sub-2 adds these results of selection together (2012).

When the result of the operation of the barrel shifter Barrel Shifter-2 is to be accommodated within a bit width of the mantissa part of the single precision, the rounding detection unit Round decides whether or not rounding is needed (step 2013).

If, as a result of the result of decision on the rounding, the rounding is found to be necessary, the selector mux2-1 selects the result of the operation of the adder/subtractor Add/Sub-2. If conversely the rounding has been found to be unnecessary, the selector mux2-1 selects the result of the operation of the barrel shifter Barrel Shifter-2 (step 2014).

Under control by the PE Ctr-2, the selector mux15 selects the result of selection by the selector mux2-1. The formatting unit (form) takes the sign part of opr1 into the sign part of the result of the operation, while taking the result of the operation of the adder Add into the exponent part of the result of the operation. The formatting unit (form) selects the lower 23 bits of the result of the selection of the selector mux15 as the mantissa part of the result of the operation. The formatting unit also sets the format to the form of single precision of IEEE754, and saves the result in an optional register of the general purpose register set RegFiles-2 (step 2015).

The steps 2008 to 2015 are executed at the fifth cycle t+4, as shown in FIG. 10, to terminate the execution of the multi-cycle floating decimal point add/subtract instruction.

Here, the multi-cycle floating decimal point add/subtract instruction is divided into a plurality of pipelines, so that the latency and the throughput will come to a close in four cycles and in one cycle, respectively. It is however also possible to select the configurations for the latency and the throughput so as to be optimum and to freely change the number of PEs making up one group as well as the configuration within each PE in keeping with the so selected configurations for the latency and the throughput.

With the present exemplary embodiment, described above, it is possible to add

a plurality of selectors (mux00˜mux06 and mux08˜mux14);

a Leading-One:

an adder Add; and

a rounding detection unit Round

to the previous exemplary embodiment to expand the control circuit of each of PE Ctr-1 and the PE Ctr-2 to implement a multi-cycle floating decimal point add/subtract instruction.

Since it is unnecessary to newly add an adder/subtractor, a barrel shifter or a register of a larger circuit size, it is sufficient to add only a minor amount of circuits in comparison with the case of newly adding a floating decimal point add/subtract circuit.

If a multi-cycle floating decimal point add/subtract instruction is to be implemented by the combination of instructions executable by a single PE, bit operations that express the floating decimal point by an integer system is preferentially used. Hence, about 4000 cycles are needed to add or subtract two single precision operands.

In contrast, with the present exemplary embodiment, even though the number of the floating decimal point add/subtract instructions that may be executed simultaneously is halved, each instruction may be executed in four cycles. It is thus possible to improve the performance by a factor of about 500 in comparison with the case of implementing the instruction with a single PE.

### Exemplary Embodiment 3

In an exemplary embodiment 3, a reconfigurable SIMD processor in which, when one group is composed of a plurality of PEs, such group executes a multi-cycle floating point multiply instruction, is described in detail. The present invention is not to be limited to the configuration of the exemplary embodiment 3. Here, the exemplary embodiment 3 is described using the IEEE754 single precision as the form for representing the floating decimal point numbers, as in the exemplary embodiment 2. Although the IEEE754 single precision is used here as the form for representing the floating decimal point numbers, it is of course possible to use other forms of expression.

The global configuration of the SIMD processor of the present exemplary embodiment is similar to that of the exemplary embodiment 1 shown in FIG. 1. The description of FIG. 1 here is dispensed with.

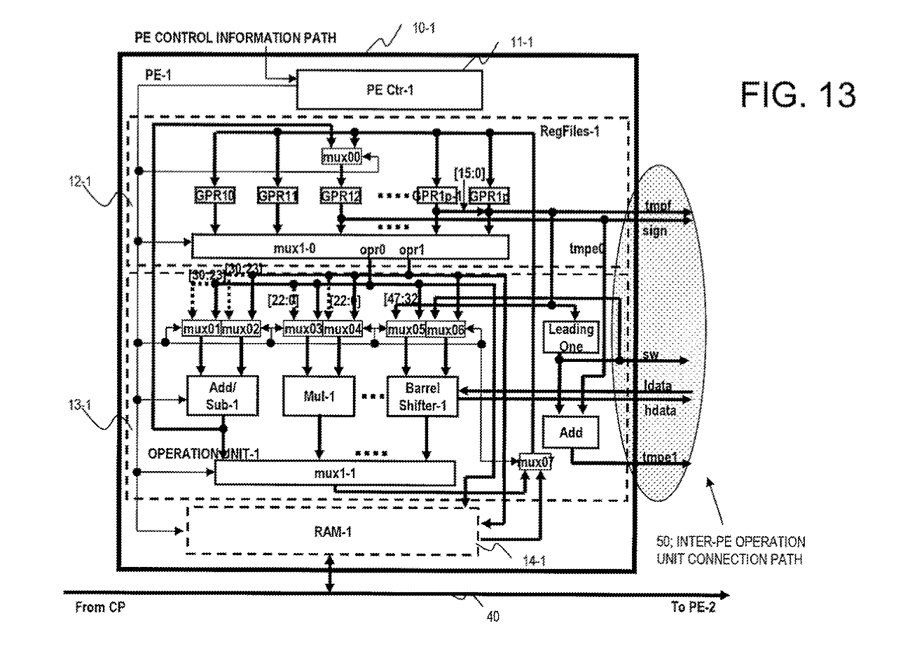

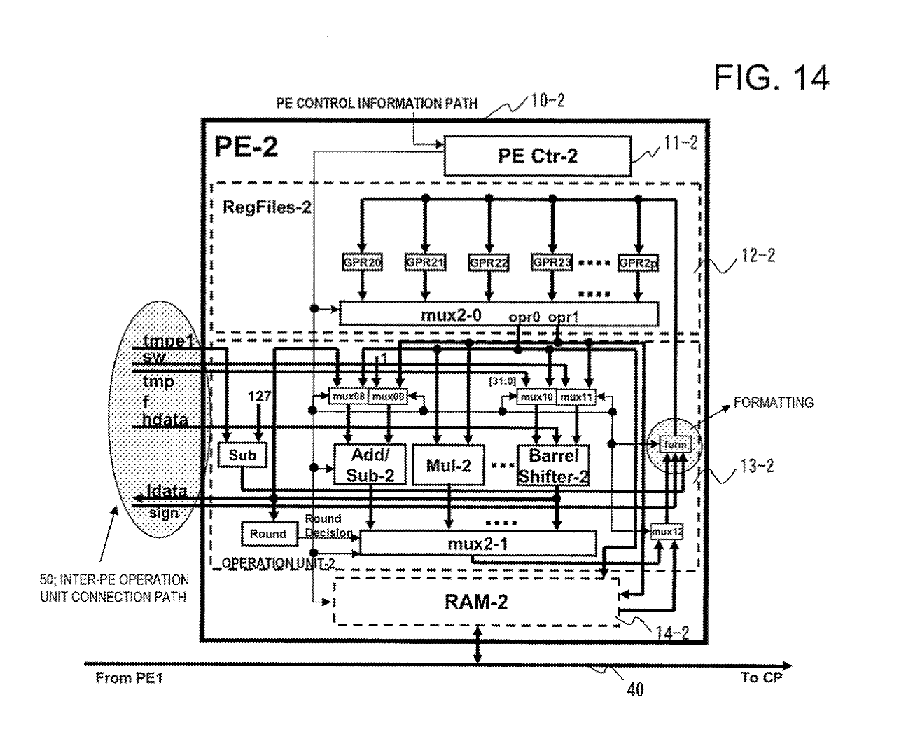

FIGS. 13 and 14 show examples of the configurations of PE-1 and PE-2 in the present exemplary embodiment, respectively. The present exemplary embodiment is directed to a case in which, when one group executes a multi-cycle floating decimal point multiply instruction, such group includes two PEs. The present invention is not limited to this configuration such that one group may be made up of three or more PEs. The role sharing configuration between the PE-1 and the PE-2 as now described is also merely illustrative and the present invention is not to be limited to this configuration.

Referring to FIGS. 13 and 14, the PE-1 receives lower order data ldata of the intermediary shift result from the PE-2 via the inter-PE operation unit connection path 50. Also, the PE-1 provides the PE-2 with upper data hdata of the intermediary result of the mantissa part tmpf, intermediary sign result (sign), the shift bit width (sw) and with the intermediary result of the exponent part tmpe1. In the following, the PE-1 is explained with reference to FIG. 13.

The general purpose register set RegFiles-1 of the PE-1 includes a plurality of registers GPR10˜GPR 1P. The GPR 12 is updated by the result of selection by the selector mux00, while the GPR10, GPR11 and the GPR13˜GPR1p are updated by the result of selection of the selector mux07.

It is observed that the GPR 1p-1 and GPR 1p are handled as special registers that store upper half bits and lower half bits of the result of multiplication. Hence, separate dedicated selectors are used for GPR 1p-1 and GPR 1p. This is not relevant to the subject-matter of the present invention and hence is not shown in FIG. 13. The outputs of the registers are selected by the selector mux1-0, controlled by the PE Ctr-1, so as to be supplied as operands (opr0, opr1) to the operation unit set-1 and to the RAM-1.

The selector mux00 selects, under control by the PE Ctr-1, one of the results of the operation by the adder/subtractor Add/Sub-1 and the result of selection by the selector mux07, under control by the PE Ctr-1, to supply the selected one to the GPR 12.

The operation unit set-1 of the PE-1 includes an adder/subtractor Add/Sub-1, a multiplier Mul-1 and a barrel shifter Barrel Shifter-1.

The adder/subtractor Add/Sub-1 executes an operation on the result of selection by the selector mux01 and the result of selection by the selector mux02, as operands, under control by the PE Ctr-1.

The multiplier Mul-1 executes an operation on the result of selection by the selector mux03 and the result of selection by the selector mux04, as operands, under control by the PE Ctr-1.

The barrel shifter Barrel Shifter-1 executes an operation on the result of selection by the selector mux05 and the result of selection by the selector mux06, as operands, under control by the PE Ctr-1.

The results of the operation are selected by the selector mux1-1, controlled by the PE Ctr-1, so as to be supplied to the selector mux07.

The selector mux01 selects one of a bit string and opr0, under control by the PE Ctr-1, and provides the selected one to the adder/subtractor Add/Sub-1. The bit string is composed of an exponent part [30:23] of opr0 of single precision of IEEE754, as lower order bits, and 0s added to its upper order side.

The selector mux02 selects a bit string or opr1, under control by the PE Ctr-1, and provides the result of the selection to the adder/subtractor Add/Sub-1. The bit string is composed of an exponent part [30:23] of opr1 of single precision of IEEE754, as lower order bits, and 0s added as upper order bits.

The selector mux03 selects one of a bit string and opr0, under control by the PE Ctr-1, and provides the result of the selection to the multiplier Mul-1. The bit string is composed of an exponent part [22:0] of opr0 of single precision of IEEE754, as lower order bits, a 1 as the next upper order bit and 0s as further upper order bits.

The selector mux04 selects one of a bit string and opr1, under control by the PE Ctr-1, and provides the so selected one to the multiplier Mul-1. The bit string is composed of an exponent part [22:0] of opr1 of single precision of IEEE754, as lower order bits, 1 as the next upper order bit and 0s as further upper order bits.

The selector mux05 selects one of a bit string or opr0, under control by the PE Ctr-1, and provides the so selected one to the barrel shifter Barrel Shifter-1. The bit string is composed of upper order 16 bits of a bit string tmpf and 0s added as upper order bits to the 16 bits. The bit string tmpf is composed of 16 lower order bits of the GRP 1p-1 as higher order bits and 32 bits of the GRP 1p as lower order bits.

The selector mux06 selects one of the result of the operation by the Leading-One and opr1 and provides the so selected one to the barrel shifter Barrel Shifter-1.

The operation unit set-1 of the PE-1 includes a Leading-One and an adder Add, used only for execution of the floating decimal point add/subtract instruction.

The Leading-One retrieves the bit string of tmpf from its MSB side to calculate a distance sw from the MSB side up to first occurrence of 1. The so calculated distance is supplied to the adder Add, selector mux06 and to the PE-2.

The adder Add sums the intermediary result tmpe0 of the mantissa part, stored in the GPR 12, and the result of retrieval by the Leading-One, to each other, to store the result in the PE-2.

The RAM-1 of the PE-1 includes memory devices, and writes data from the general purpose register set RegFiles-1 and the EMEM data transfer network in the memory devices, under control by the PE Ctr-1. Data read from the memory devices of the RAM -1 of the PE-1 are provided to the selector mux07 and to the EMEM data transfer network.

The selector mux07 selects one of the results of selection by the selector mux1-1 and the results read from the RAM-1, under control by the PE Ctr-1, and provides the so selected one to the general purpose register set RegFiles-1.

Referring to FIG. 14, the PE-2 receives the intermediary result of the mantissa part tmpf, intermediary result tmpe 1 of the exponent part, sw and sign result (sign), as the intermediary results of the floating decimal point multiply instruction, and upper data hdata of shift intermediary result, from PE-1, via the inter-PE operation unit connection path 50. The PE-1 then provides lower order data ldata of the intermediary shift result to the PE-1. Referring to FIG. 14, the PE-2 will now be described.

The general purpose register set RegFiles-2 of the PE-2 includes a plurality of registers GPR 20˜GPR 2p, and is updated by the result of selection of the formatting unit (form). The register outputs are selected by the selector mux2-0, controlled by the PE Ctr-2, so as to be supplied as operands (opr0, opr1) to the operation unit set-2 and to the RAM-2.

The operation unit set-2 includes an adder/subtractor Add/Sub-2, a multiplier Mul-1 and a barrel shifter Barrel Shifter-2.

The adder/subtractor Add/Sub-2 executes an operation on the results of the selection of the selectors mux08 and mux09, as operands, under control by the PE Ctr-2.

The multiplier Mul-2 executes an operation on opr0 and opr1, as operands, under control by the PE Ctr-2.

The barrel shifter Barrel Shifter-2 executes an operation on the results of the selection of the selectors mux10 and mux11, as operands, under control by the PE Ctr-2.

The result of the operation is selected by the selector mux2-1, controlled by the PE Ctr-2, so as to be supplied to the selector mux12.

The selector mux08 selects one of the result of the operations by the barrel shifter Barrel Shifter-2 and opr0, under control by the PE Ctr-2, and supplies the so selected one to the adder/subtractor Add/Sub-2.

The selector mux09 selects one of the value 1 and opr1, under control by the PE Ctr-2, and provides the so selected one to the adder/subtractor Add/Sub-2.

The selector mux10 selects one of the lower 32 bits of tmpf [31:0] and opr0, under control by the PE Ctr-2, and provides the so selected one to the barrel shifter Barrel Shifter-2.

The selector mux11 selects one of the shift width sw, provided from the PE-1 via the inter-PE operation unit connection path 50, and opr0, under control by the PE Ctr-2, and provides the so selected one to the barrel shifter Barrel Shifter-2.

The operation unit set-2 of the PE-2 includes a subtractor Sub and a rounding detection unit Round, used exclusively for executing the floating decimal point add/subtract instruction, as constituent elements.

The subtractor Sub subtracts 127 from temp1, and provides the result of subtraction to the formatting unit (form).

The rounding detection unit Round decides whether or not the result of the operations by the barrel shifter Barrel Shifter-2 is in need of rounding, and sends the result verified to the selector mux2-1.

The RAM-2 of PE-2 includes a plurality of memory elements, and writes data from the RegFiles-2 and from the EMEM data transfer network in the memory devices, or sends the data read from the memory devices to the selector mux12 and to the EMEM data transfer network, under control by the PE Ctr-2.

The selector mux12 selects one of the result of selection by the selector mux2-1 and the read result from the RAM-2, under control by the PE Ctr-2, and sends the so selected one to the formatting unit (form).

The formatting unit (form) selects one of the result of selection by the selector mux12, the result of the operation by the subtractor Sub and the result of the sign (sign), supplied from PE-1. The formatting unit sends the selected result to the general purpose register set RegFiles-2.

The formatting unit (form) selects the result of selection of the selector mux12, as the mantissa part, while selecting the result of the operation of the subtractor Sub as the exponent part and selecting the result of the sign (sign), supplied from the PE-1, as the sign, under control by the PE Ctr-2. The formatting unit also sets the format to the form of single precision of IEEE754, and saves the result in an optional register of the general purpose register set RegFiles-2.

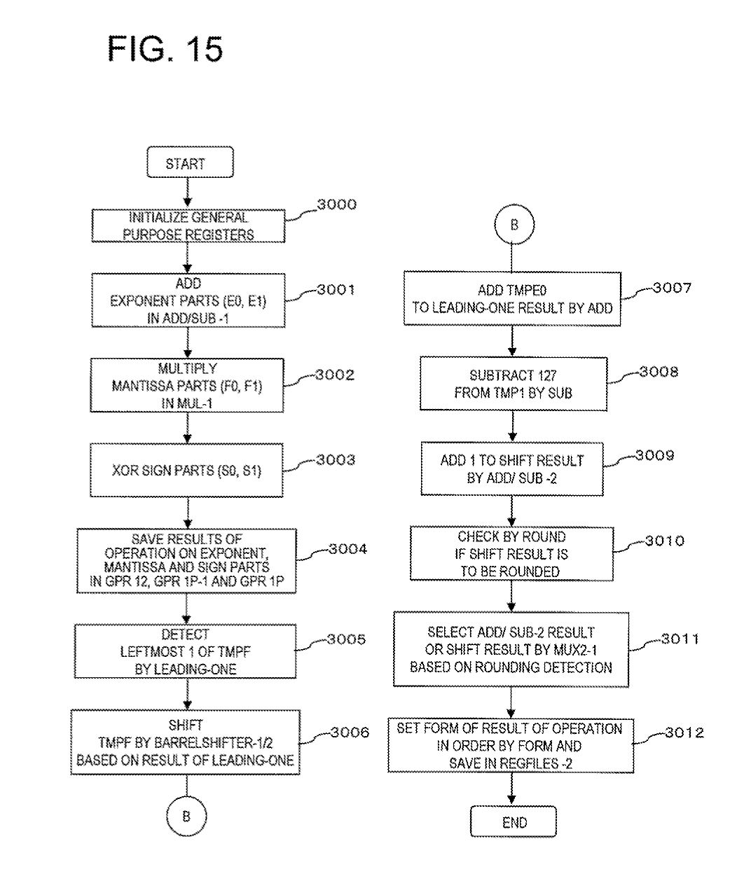

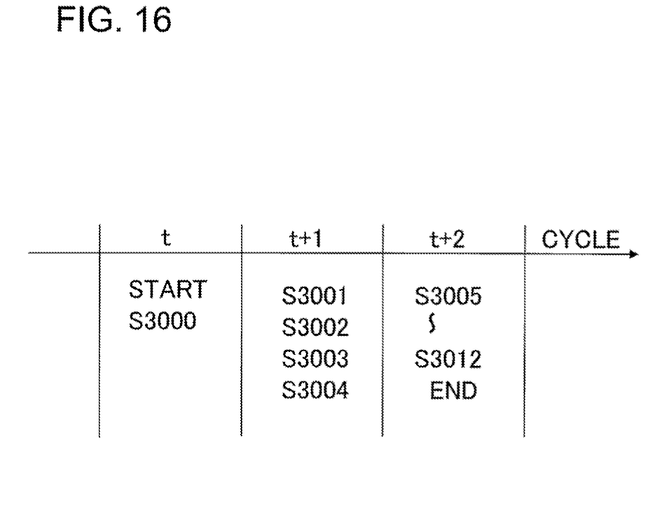

FIG. 15 is a flowchart for a reconfigurable SIMD processing method by a reconfigurable SIMD processor of the exemplary embodiment 3 shown in FIGS. 1, 13 and 14. If, in the SIMD processor, a group includes a plurality of PEs, such group executes a multi-cycle floating decimal point multiply instruction. FIG. 16 is a timing chart according to which respective steps of FIG. 15 are to be executed. Referring to FIGS. 15 and 16, the reconfigurable SIMD processor, configured for executing a multi-cycle floating decimal point multiply instruction, is described in detail.

Initially, the PE-1 initializes the GPR 10 and the GPR 11 to the operand 0 (fopr0) and the operand 1 (fopr1) of the floating decimal point, respectively (step 3000). This step 3000 is executed by the first cycle t, as shown in FIG. 16.

In the step 3000, the registers to be initialized are GPR 10 and GPR 11. The present invention is not limited to this configuration and any optional registers may be initialized.

The operand of the floating decimal point may be expressed by designation by an immediate value or by the combination of two or more registers.

Then, under control by the PE Ctr-1, the selector mux1-0 selects the GPR 10 and the GPR 11 as opr0 and opr1, respectively. The selectors mux01 and mux02 select the exponent parts (E0, E1) of opr0 and opr1, while the adder/subtractor Add/Sub-1 adds the exponent parts (step 3001).

Under control by the PE Ctr-1, the selectors mux03 and mux04 select the mantissa parts (F0, F1) of opr0 and opr1, and the multiplier Mul-1 multiplies the mantissa parts by each other (step 3002).

The XOR (Exclusive OR) of the sign parts (S0, S1) of opr0 and opr1 is calculated by a newly provided XOR device, which is not shown in FIG. 13 for simplicity of the drawing (step 3003).

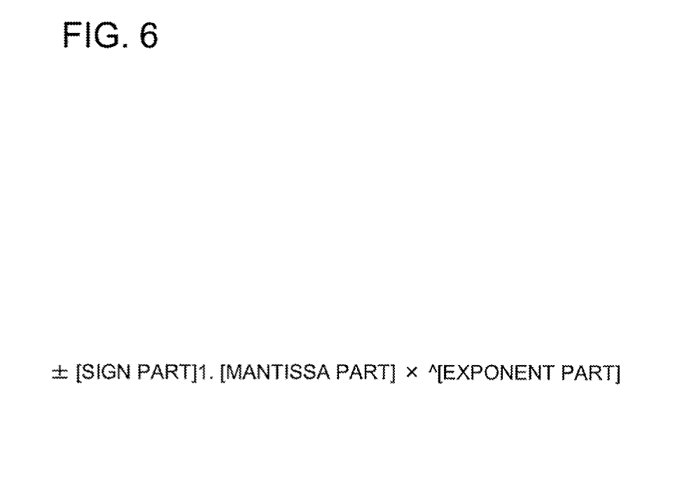

Under control by the PE CTR-1, the selector mux00 selects a bit string, composed of the result of addition of the exponent parts on the upper order side of which is placed the result of the XOR operation. The result of the selection is saved in the GPR 12. The selector mux-1 selects the result of the operation of the multiplier Mul-1. The lower order half of the result of the operation is saved in the GPR 10, while its upper half is saved in the GPR 1p-1 (step 3004). Referring to FIG. 6, the steps 3001 to 3004 are executed at the second cycle t+1.

A bit string tmpf, composed of the bit string saved in the GPR 1p, to an upper order side of which is added a lower half of the bit string GPR 1p-1, is supplied as input to the Leading-One. The bit string tmpf is scanned from its MSB side towards its LSB side, and the number of bits from the MSB to the first occurrence of 1 is counted (step 3005).

Under control by the PE Ctr-1, the selector mux05 selects upper 16 bits of tmpf, and the selector mux06 selects the result of the operation of the Leading-One.

Under control by the PE Ctr-2, the selector mux10 selects lower 32 bits of tmpf, and the selector mux11 selects the result of the operations sw by the Leading-One supplied via the inter-PE operation unit connection path 50. Under control by the PE Ctr-1/2, shift data is exchanged between the selector mux11 and the barrel shifter Barrel Shifter-1/2 via the inter-PE operation unit connection path 50 to bit-shift tmpf by sw (step 3006).

The adder Add adds the intermediary result of the exponent parts, stored in the GPR 12, to the result of the operations sw by the Leading-One (step 3007).

The subtractor Sub subtracts 127 from the intermediary result tmpe1 of the exponent parts supplied from the PE-1 via the inter-PE operation unit connection path 50 (step 3008).

Under control by the PE Ctr-2, the selector mux08 selects the result of the operation of the barrel shifter Barrel Shifter-2, the selector mux09 selects 1 and the adder/subtractor Add/Sub-2 sums the results of the selection together (step 3009).

When the result of the operation of the barrel shifter Barrel Shifter-2 is to be accommodated within a bit width of the mantissa part of the single precision, the rounding detection unit Round decides whether or not it is necessary to perform the rounding (step 3010).

If, as a result of the result of decision on the rounding, the rounding is found to be necessary, the selector mux2-1 selects the result of the operation of the adder/subtractor Add/Sub-2. If conversely the rounding has been found to be unnecessary, the selector mux2-1 selects the result of the operation of the barrel shifter Barrel Shifter-2 (step 3011).

Under control by the PE Ctr-2, the selector mux12 selects the result of selection by the selector mux2-1. The formatting unit (form) takes the Sign supplied from the PE-1 via the inter-PE operation unit connection path 50 into the sign part of the result of the operation, while taking the result of subtraction of the subtractor Sub into the exponent part of the result of the operation. The formatting unit (form) selects the lower 23 bits of the result of the selection of the selector mux12 as the mantissa part of the result of the operation. The formatting unit also sets the format to the form of single precision of IEEE754, and saves the result in an optional register of the general purpose register set RegFiles-2 (step 3012).

The steps 3005 to 3012 are executed at the third cycle t+2, as shown in FIG. 16, to terminate the execution of the multi-cycle floating decimal point multiply instruction.

Here, the multi-cycle floating decimal point multiply instruction is divided into a plurality of pipelines, so that the latency and the throughput will come to a close in two cycles and in one cycle, respectively. It is however also possible to select optimum configurations for the latency and the throughput and to freely change the number of PEs making up one group and the configuration within each PE in keeping with the so selected configurations for the latency and the throughput. A variety of other configurations may also be used within the technical scope of the present invention.

With the present exemplary embodiment, described above, the multi-cycle floating decimal point multiply instruction may be implemented by adding a plurality of selectors (mux00˜mux06 and mux08˜mux11), a Leading-One, an adder Add and a rounding detection unit Round, and by expanding the control circuitry for the PE Ctr-1 and PE Ctr-2.

Since it is unnecessary to newly add an adder/subtractor, a multiplier, a barrel shifter or a register of larger circuit size, the size of the circuit to be added may be only small in comparison with the case of newly adding a circuit for floating decimal point multiplication.

In addition, since the Leading-One, adder Add or the rounding detection unit Round, used in subsequent processing of the floating decimal point instruction, and those used in the floating decimal point add/subtract instruction, may be used in common. Hence, in case of executing a plurality of floating decimal point instructions, it is possible to further suppress the circuit from increasing in size.

If a multi-cycle floating decimal point add/subtract instruction is to be implemented by the combination of instructions executable by a single PE, bit operations that express the floating decimal point by an integer system is frequently used. Hence, about 2000 cycles are needed to add or subtract two single precision operands. In contrast, with the present exemplary embodiment, even though the number of the floating decimal point add/subtract instructions that may be executed simultaneously is halved, each instruction may be executed in two cycles, and hence the performance may be improved by a factor of ca. 5000 in comparison with the case of implementing the instruction with a single PE.

### Exemplary Embodiment 4

In the exemplary embodiment 4, a reconfigurable SIMD processor in which, when one group is composed of a plurality of PEs, such group executes a multi-cycle floating point divide instruction, is described in detail. The present invention is not to be limited to the configuration of the exemplary embodiment 4. The exemplary embodiment 4 uses the IEEE754 single precision as the form for representing the floating decimal point numbers, as in the exemplary embodiments 2 and 3. However, it is of course possible to use other forms for representing the floating decimal point numbers.

FIG. 1 is a block diagram showing the configuration of the exemplary embodiment 4 of the present invention. The global configuration of the SIMD processor of the present exemplary embodiment is similar to that of the exemplary embodiments 1 to 3 shown in FIG. 1. The description of FIG. 1 here is dispensed with.

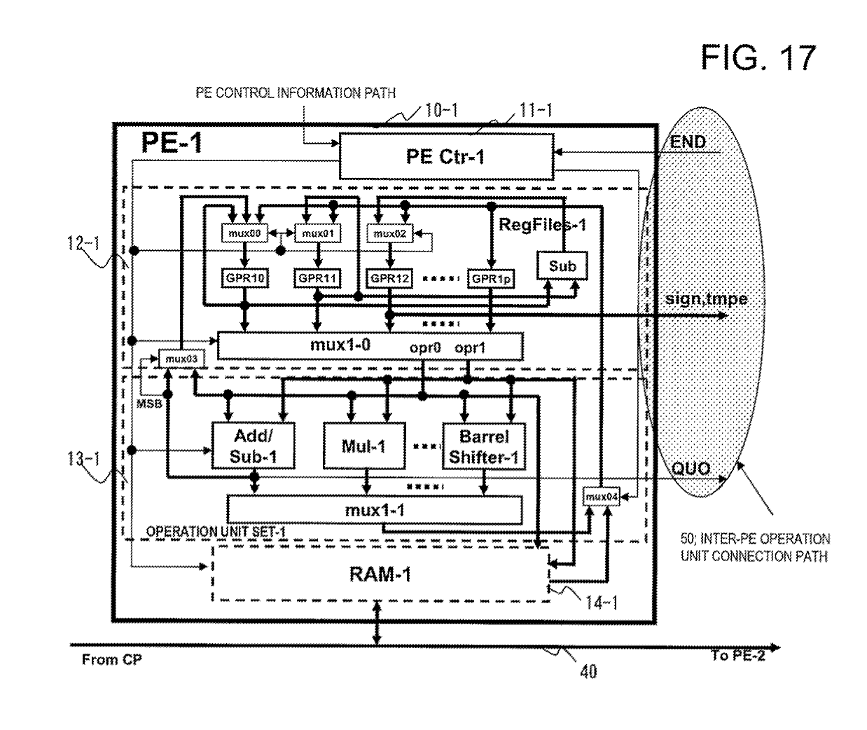

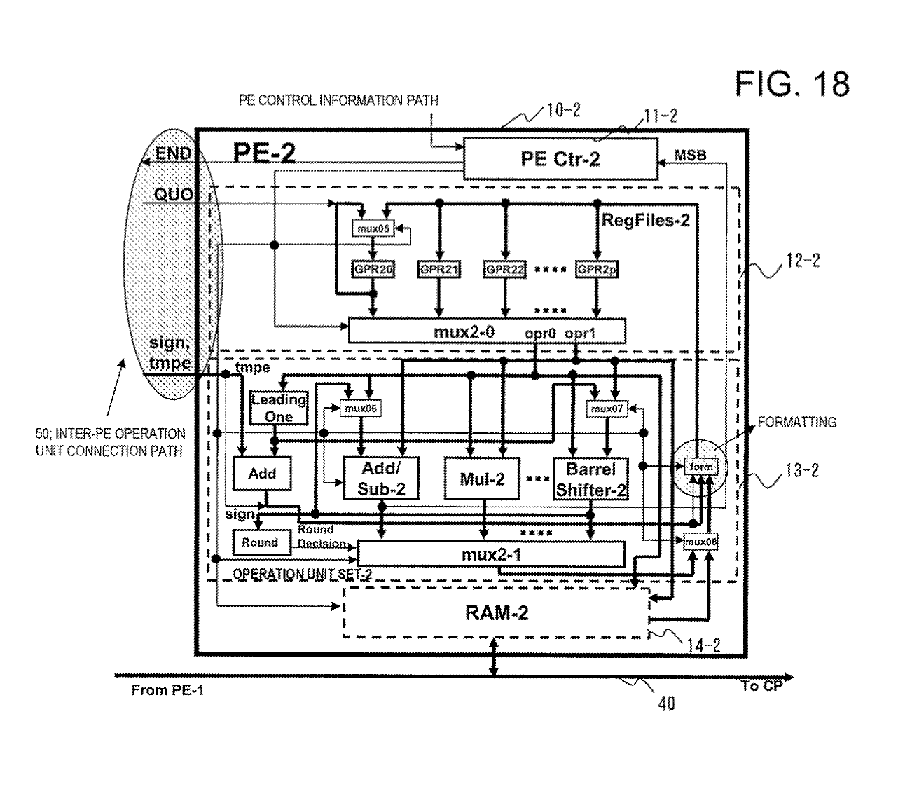

FIGS. 17 and 18 show examples of the configurations of PE-1 and PE-2 in the present exemplary embodiment.

In the present exemplary embodiment, a case in which, when one group executes a multi-cycle floating decimal point divide instruction, such group includes two PEs, will be described. The present invention is not limited to this configuration only such that one group may be made up of three or more PEs. The role sharing between the PE-1 and the PE-2 is merely illustrative and the present invention is not to be limited to this configuration.

Referring to FIGS. 17 and 18, the PE-1 receives an end signal END of the multi-cycle floating decimal point divide instruction from the PE-2 via the inter-PE operation unit connection path 50. The PE-1 then provides a sign (sign) of the result of the operations, an intermediary result of the exponent parts tmpe and a digit of the result of the division QUO to the PE-2. In the following, the detailed configuration of the PE-1 is explained with reference to FIG. 17.

The general purpose register set RegFiles-1 includes a plurality of registers GPR 10˜GPR 1p. The GPR 10, GPR 11 and GPR 12 are updated by the results of selection by selectors (mux00, mux01 and mux12), while the GPR 13˜GPR 1p are updated by the result of selection by the selector mux04. The outputs of these registers are selected by the selector mux1-0, controlled by the PE Ctr-1, and are supplied as operands (opr0, opr1) to the operation unit set-1 and to the RAM-1.

The selector mux00 selects, under control by the PE Ctr-1, one of a bit string corresponding to GPR 10, an upper bit of the single precision mantissa part [22:0] of which is set to 1 and further upper bits of which are set to 0s, the result of selection of the selector mux03 and the result of selection of the selector mx4. The selector mx00 supplies a selected one to GPR 10.

The selector mux01 selects, under control by the PE Ctr-1, one of a bit string corresponding to GPR 10, an upper bit of the single precision mantissa part [22:0] of which is set to 1 and further upper bits of which are set to 0s, and the result of selection of the selector mx4. The selector mx00 supplies a selected one to GPR 11.

Under control by the PE Ctr-1, the selector mux02 selects one of the result of subtraction of the subtractor Sub and the result of selection of the selector mux4, and deliver the selected one to the GPR 11.

The general purpose register set RegFiles-1 of the PE-1 includes, as a constituent element, a subtractor Sub used exclusively for executing the floating decimal point divide instruction. The subtractor subtracts the single precision exponent part [30:24] of the GPR 11 from the single precision exponent part [30:24] of the GPR10 to supply the result of the subtraction to the selector mux02.

An XOR (Exclusive OR) element, not shown in FIG. 17 for simplicity of the drawing, takes XOR of the single precision sign part [31] of the GPR 10 and the single precision sign part [31] of the GPR 11. The result of the XOR operation is supplied to the selector mux2.

The operation unit set-1 of the PE-1 includes an adder/subtractor Add/Sub-1, a multiplier Mul-1 and a barrel shifter Barrel Shifter-1. Under control by the PE Ctr-1, the respective operation units perform operations on the operands (opr0, opr1) supplied from the selector mux1-0. The results of the operations are selected by the selector mux-1, controlled by the PE Ctr-1, so as to be supplied to the selector mux04. It should be observed that the configuration of the operation unit set-1 of PE-1 is merely illustrative and the present invention is not to be limited to this illustrative configuration.

The RAM-1 of the PE-1 is formed by memory devices, and writes data from the general purpose register set RegFiles-1 and from the EMEM data transfer network in the memory devices, under control by the PE Ctr-1. Or, the RAM-1 of the PE-1 provides data read from the memory devices to the selector mux04 and to the EMEM data transfer network.

The selector mux04 selects one of the result of selection by the selector mux1-1 and the read result of the RAM-1, under control by the PE Ctr-1, and sends the selected one to the general purpose register set RegFiles-1.

Referring to FIG. 18, the PE-2 receives one digit of the result of division QUO, the intermediary result of the exponent part, as an intermediary result of the floating decimal point multiply instruction, and the sign result (sign) from the PE-1. The PE-2 then sends the floating decimal point division end signal END to the PE-1. Referring to FIG. 18, the configuration of the PE-2 is now described.

The general purpose register set RegFiles-2 of the PE-2 includes a plurality of registers GPR 20˜GPR 2p.

The GPR 20 is updated by the result of selection by the selector mux05, while the GPR 21˜GPR 2p are updated by the result of selection by the formatting unit (form). The GPR outputs are selected by the selector mux2-0, controlled by the PE Ctr-2, so as to be supplied as operands (opr0, opr1) to the general purpose register set RegFiles-2 and to the RAM-2.

Under control by the PE Ctr-2, the selector mux05 selects one of a bit string obtained on removing the MSB from the bit string of the GPR 20 and on adding a digit of the result of division QUO, supplied from the PE-1 via the inter-PE operation unit connection path 50, to the LSB, and the result of selection by the formatting unit (form). The selector mux05 sends the selected one to the GPR 20.

The operation unit set-2 of the PE-2 includes an adder/subtractor Add/Sub-2, a multiplier Mul-2 and a barrel shifter Barrel Shifter-2.

The adder/subtractor Add/Sub-2 performs an operation on the result of selection by the selector mux06 and opr1 as operands. The multiplier Mul-2 performs an operation on opr0 and opr1 as operands, while the barrel shifter Barrel Shifter-2 performs an operation on opr0 and on the result of selection by the selector mux07 as operands. These operations are performed under control by the PE Ctr-2.

The results of the above operations are selected by the selector mux2-1, under control by the PE Ctr-2, and are supplied to the selector mux08.

Under control by the PE Ctr-2, the selector mux06 selects one of the result of the operation of the barrel shifter Barrel Shifter-2 and opr0, and sends the one selected to the adder/subtractor Add/Sub-2.

Under control by the PE Ctr-2, the selector mux07 selects one of the result of the operation of the Leading-One and opr1, and sends the one selected to the adder/subtractor Add/Sub-2.

The operation unit set-2 of the PE-2 includes the Leading-One, an adder Add and a rounding detection unit Round, used exclusively for executing the floating decimal point divide instruction.

The Leading-One retrieves the bit string of opr0 from its MSB side to its LSB side to calculate the distance from the MSB to the first occurrence bit of 1. The Leading-One provides the so calculated distance to the adder Add and to the selector mux07.

The adder Add sums the exponent intermediary result trope, supplied from the PE-1 via the inter-PE operation unit connection path 50, to the result of the operations by the Leading-One, and provides the result of the addition to the formatting unit (form).

The rounding detection unit Round decides on whether the result of the operation by the barrel shifter Barrel Shifter-2 is in need of rounding, and provides the result of the decision to the selector mux2-1.

The RAM-2 of the PE-2 is formed by memory devices, and writes data from the general purpose register set RegFiles-2 and from the EMEM data transfer network in the memory devices, under control by the PE Ctr-2. Or, the RAM-2 of the PE-2 provides data read from the memory devices to the selector mux08 and to the EMEM data transfer network 40.

Under control by the PE Ctr-2, the selector mux08 selects one of the result of the selection by the selector mux2-1 and the read result from the RAM-2, and sends the so selected one to the formatting unit (form).

Under control by the PE Ctr-2, the formatting unit (form) selects one of the result of the selection by the selector mux08, the result of the addition of the Adder Add and the sign result (sign), provided by the PE-1. The formatting unit (form) provides the result of the selection to the general purpose register set RegFiles-2.

Under control by the PE Ctr-2, the formatting unit (form) selects the result of the selection of the selector mux08 as the mantissa part, while selecting the result of addition of the adder Add as an exponent part and selecting the result of the sign (sign) as the sign part. The formatting unit (form) also sets the format to the form of single precision of IEEE754, and saves the result in an optional register of the general purpose register set RegFiles-2.

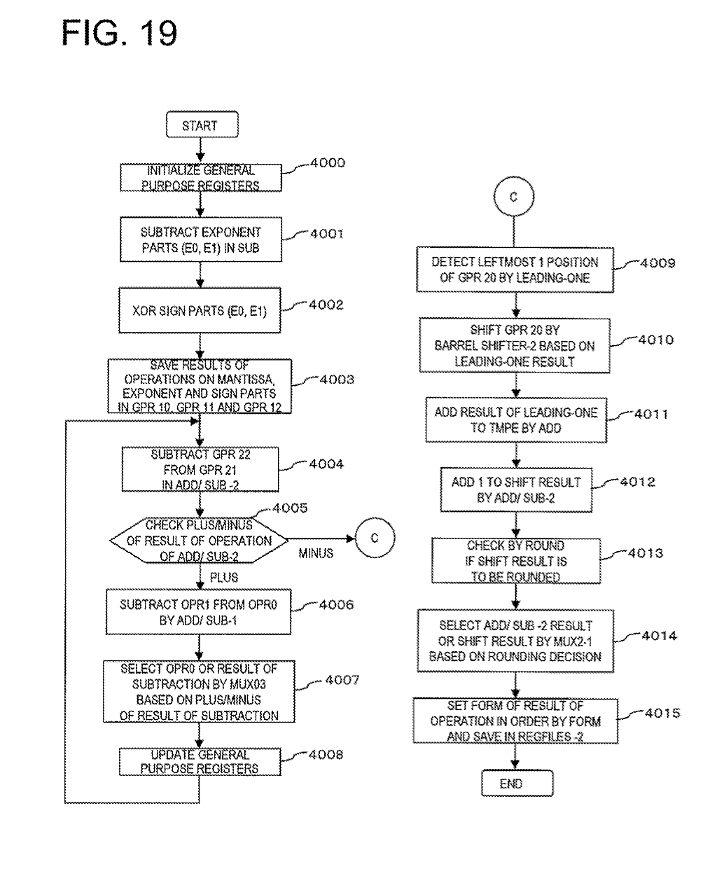

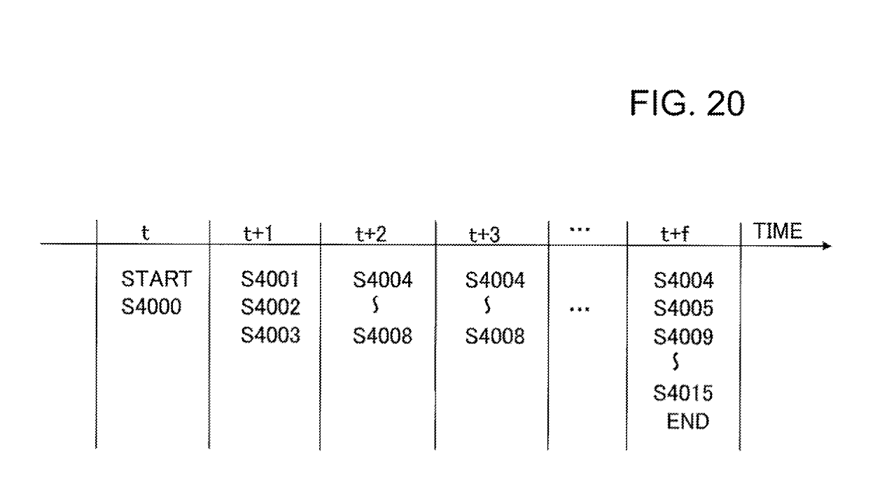

FIG. 19 is a flowchart for illustrating the operation of a reconfigurable SIMD processor of the exemplary embodiment shown in FIGS. 17 and 18, in which, when one group is formed by a plurality of PEs, such group performs the multi-cycle floating decimal point divide instruction. FIG. 20 is a timing chart showing the timing of execution of the respective steps. Referring to FIGS. 19 and 20, the reconfigurable SIMD processor that performs the multi-cycle floating decimal point divide instruction is now explained.

First, the PE-1 initializes the GPR 10 to the operand 0 of the floating decimal point (fopr0), while initializing the GPR 11 to the operand 1 of the floating decimal point (fopr1). The PE-2 initializes the GPR 21 to the number of cycles needed for division of the GPR 21, while initializing the GPR 22 to 1 (step 4000).

Here, the registers to be initialized are GPR10, GPR11, GPR21 and GPR22. The present invention is not to be limited to this configuration and the registers to be initialized may be any optional registers.

A step 4000 is executed at the first cycle t, as shown in FIG. 20.

The subtractor Sub subtracts the exponent part (E1) of the GPR 11 from the exponent part (E0) of the GPR 10 (step 4001).

An XOR (Exclusive OR) element, not shown in FIG. 17 for simplicity of the drawing, takes XOR of the sign part (S0) of the GPR 10 and the sign part [S1] of the GPR 11 (step 4002).

Under control by the PE Ctr-1,

the selector mux00 of the PE-1 selects one of the mantissa part (F0) and a bit string corresponding to the mantissa part (F0) to the MSB side of which is added 1,

with 0s being combined in an upper side of this bit 1, to update the GPR 10.

The selector mux01 selects one of the mantissa part (F1) and a bit string corresponding to the mantissa part (F1) to the MSB side of which is added 1, with 0s being combined in an upper side of this bit 1, to update the GPR 11.

The selector mux2 selects a bit string corresponding to the result of subtraction of the exponent part, to the MSB side of which is added the result of XOR of the sign parts, to update the GPR 12 (step 4003).

Referring to FIG. 20, the steps 4001 to 4003 are executed by the second cycle t+1. Under control by the PE Ctr-2 of PE-2, the selector mux2-0 selects the GPR 21 and the GPR 22 as operands (opr0, opr1), respectively. The adder/subtractor Add/Sub-1 then subtracts opr1 from opr0 by the adder/subtractor Add/Sub-2 (step 4004). Here, the value 1 of opr1 is provided as a register value (GPR 22). This value does not necessarily have to be a register value and may also be provided as immediate values or other means.

In case the result of the operation is positive (plus branching of step 4005), the selector mux1-0 of the PE-1 selects the GPR 10 and the GPR 11 as operands for the operation, under control by PE Ctr2. The adder/subtractor Add/Sub-1 subtracts opr1 from opr0 (step 4006).

In case the result of the subtraction is positive, the selector mux03 selects a bit string corresponding to the result of the subtraction from which the MSB is removed and to the LSB of which is added 0 (step 4007).

Then, in the PE-1, the selector mux00 selects the result of the selection of the selector mux03 to update the GPR 10. The selector mux01 selects the value of the GPR 11 to update GPR 11, while the selector mux02 selects the result of the GPR 12 to update GPR 12 (step 4008). These selection operations are performed under control by the PE Ctr-1.

On the other hand, in the PE-2, the selector mux2-1 selects the result of the operations of the adder/subtractor Add/Sub-2, while the selector mux08 selects the result of selection of the selector mux2-1. The formatting unit (form) selects the result of the selection and updates the GPR 21 by the result of the selection. The selector mux05 selects a bit string corresponding to the value of the GPR 20 which has been got rid of the MSB and to the LSB of which is added one digit QUO of the result of the division provided by the PE-1 via the inter-PE operation unit connection path 50. The GPR 20 is updated with the bit string in question (step 4008). These operations are performed under control by the PE Ctr-1.

Referring to FIG. 20, the steps 4004 to 4008 are executed at the same cycle. In case the result of the operation of the adder/subtractor Add/Sub-2 is positive, the operations are reiterated a plurality of cycles.

In case the result of the operation is negative (C of the negative branch destination of step 4005),

the selector mux2-0 of the PE-2 selects the GPR 20 and the GPR 22 as operands (opr20 and opr22) by the selector mux2-0, under control by the PE Ctr-2, at the next cycle; and

opr0 is supplied to the Leading-One, and a bit string is scanned from the MSB side to the LSB side of the bit string of opr0. The number of bits from the MSB to the first occurrence of 1 is counted (step 4009).

Then, under control by the PE Ctr-2, the selector mux07 selects the result of the operations of the Leading-One, and the barrel shifter Barrel Shifter-2 bit-shifts the opr0 based on the result of the selection (step 4010).

The adder Add sums the result of the operation of the Leading-One to the intermediary result of the exponent part provided from the PE-1 via the inter-PE operation unit connection path 50 (step 4011).

The selector mux06 selects the result of the operation of the barrel shifter Barrel Shifter-2, while the adder/subtractor Add/Sub-2 sums the result of the selection by the selector mux06 to opr1, under control by the PE Ctr-2 (step 4012).

When the result of the operation of the barrel shifter Barrel Shifter-2 is to be accommodated within a bit width of the mantissa part of the single precision, the rounding detection unit Round checks to see whether or not it is necessary to perform the rounding (step 4013).

If, as a result of the result of decision on the rounding, the rounding is found to be necessary, the selector mux2-1 selects the result of the operation of the adder/subtractor Add/Sub-2. If conversely the rounding has been found to be unnecessary, the selector mux2-1 selects the result of the operation of the barrel shifter Barrel Shifter-2 (step 4014).

Under control by the PE Ctr-2, the selector mux08 selects the result of selection by the selector mux2-1. The formatting unit (form) takes the result of the sign (sign) supplied from the PE-1 via the inter-PE operation unit connection path 50 into the sign part of the result of the operation, while taking the result of the operation of the adder Add into the exponent part of the result of the operation. The formatting unit (form) selects the lower 23 bits of the result of the selection of the selector mux08 as the mantissa part of the result of the operation. The formatting unit also sets the format to the form of single precision of IEEE754, and saves the result in an optional register of the general purpose register set RegFiles-2 (step 4015).

Referring to FIG. 20, the steps 4004, 4005 and 4009˜4015 are executed at the same cycle, in case the result of the operation of the adder/subtractor Add/Sub-1 is negative, to terminate execution of the multi-cycle floating decimal point divide instruction.

Here, the multi-cycle floating decimal point multiply instruction is divided into a plurality of pipelines, and one digit of the result of the division is calculated from cycle to cycle. Hence, the latency is equal to the number of digits of division. It is however possible to select the optimum configuration of the latency and the number of digits of the result of division that is to be calculated following the cycle, depending on the application as the subject. The number of the PEs making up one group and the configuration within each PE may freely be changed in keeping therewith.

With the present exemplary embodiment, described above, the multi-cycle floating decimal point divide instruction may be implemented by supplementing the selectors (mux00˜mux03, mux05˜mux07), Leading-One, adder Add, subtractor Sub and the rounding detection unit Round, and by expanding the control circuits for the PE Ctr-1 and PE Ctr-2.

Since it is unnecessary to newly add an adder/subtractor, a multiplier, a barrel shifter or a register of larger circuit size, the circuit to be added may be only small in comparison with the case of newly adding the circuit for floating decimal point division.

In addition, since the Leading-One, adder Add or the rounding detection unit Round, used in subsequent processing of the floating decimal point instruction, and those used in the floating decimal point add/subtract instruction, may be used in common. Hence, in case of executing a plurality of floating decimal point instructions, the circuit may further be suppressed from increasing in size.

In case a multi-cycle floating decimal point divide instruction is executed by the combination of instructions which the single PE is able to execute, approximately 30000 cycles, for example, are needed to divide two single precision operands. It is because bit operations are preferentially used to express the floating decimal point in an integer form.

With the present exemplary embodiment, the number of instructions of the floating decimal point divide instruction that may be executed simultaneously is halved. However, an instruction may be calculated in approximately 30 cycles. Hence, the performance may be improved by a factor of about 500 in comparison with the case of implementing the instruction by the single PE.

With the exemplary embodiment of the present invention, the combination of the operation units and the general-purpose registers of the multiple PEs is reconfigured and different roles are afforded to the respective PEs. It is thus possible to flexibly deal with subjects for processing of different characteristics and to improve the global performance of the SIMD processor. In addition, since the operation units and the general purpose registers, owned by the individual PEs, are used, it is possible to reduce the amount of additional resources that may be needed.

### INDUSTRIAL APPLICABILITY

The present invention may be applied to a reconfigurable SIMD processor that may flexibly deal with subjects for processing differing in the degree of parallelism or in the instructions optimum for processing without the necessity of significantly increasing the circuit size.

The particular exemplary embodiments or examples may be modified or adjusted within the gamut of the entire disclosure of the present invention, inclusive of claims, based on the fundamental technical concept of the invention. Further, variegated combinations or selection of elements disclosed herein may be made within the framework of the claims.

What is claimed is:

1-33. (canceled)

34. A processor for parallel operations, comprising a plurality of processing elements (PEs), wherein
a unit of operation for executing an instruction corresponds to one group, and
the one group that includes a plurality of processing elements (PEs) implements at least a part of an operation unit that executes at least one of:
an integer divide instruction;
a floating decimal point add/subtract instruction;
a floating decimal point multiply instruction; and
a floating decimal point divide instruction, using operation units and general purpose registers provided in a plurality of the PEs, the number of the PEs that compose the one group being varied in accordance with the instruction.

35. The processor for parallel operation according to claim 34, wherein in case the instruction executed by the one group is a multi-cycle integer divide instruction,
the one group includes a plurality of PEs,
a first PE in the one group operates as a counter that counts the number of cycles of the multi-cycle integer divide instruction, and
a second PE in the one group, different from the first PE, responsive to the counter, subtracts a divisor from a dividend of the multi-cycle integer divide instruction, a number of times equal to the number of cycles.

36. The processor for parallel operation according to claim 35, wherein the first PE includes:
an adder/subtractor; and
a general purpose register, and wherein
in executing the multi-cycle integer divide instruction, the first PE stores a cycle count value in the general purpose register of the first PE and updates the count value by the adder/subtractor.

37. The processor for parallel operation according to claim 35, wherein the first PE includes:
an adder/subtractor; and
a general purpose register, wherein,
in executing the multi-cycle integer divide instruction, the second PE stores a divisor, a dividend and an intermediary result of division in the general purpose register,
the adder/subtractor subtracting the dividend from the divisor and storing the result of the division in the general purpose register as the intermediary result of division

38. The processor for parallel operation according to claim 34, wherein in case an instruction executed by the one group is a multi-cycle floating decimal point add/subtract instruction,
the one group includes a plurality of PEs,
a first one of the PEs in the one group performs addition/subtraction on floating decimal point operands, and
a second PE in the one group different from the first PE performs a processing of normalizing the result of the addition/subtraction.

39. The processor for parallel operation according to claim 38, wherein the first PE includes:
an adder/subtractor;
a differentiator;
a barrel shifter; and
a general purpose register, and wherein
in executing the multi-cycle floating decimal point add/subtract instruction,
the differentiator and the barrel shifter effect the decimal point position registration in the first PE,
the adder/subtractor adds/subtracts the result of the decimal point position registration, and
the general purpose register is used as a site of temporary storage of the result of the decimal point position registration and the result of the addition/subtraction.

40. The processor for parallel operation according to claim 38, wherein the second PE includes:
an adder/subtractor;
a differentiator;
a barrel shifter;
a general purpose register; and
a normalizing controller, and wherein,
in executing the multi-cycle floating decimal point add/subtract instruction, in the second PE,
the adder/subtractor, the differentiator and the barrel shifter normalize the result of addition/subtraction of the first PE, under control by the normalizing controller, and
the general purpose register is used as a site of temporary storage of an intermediary result of the normalization.

41. The processor for parallel operation according to claim 34, wherein in case the multi-cycle instruction is a floating decimal point multiply instruction,
the one group includes a plurality of PEs,
a first PE in the one group executes processing of multiplication of two floating decimal point operands and part of normalization of the result of multiplication, and
a second PE in the group different from the first PE operates in cooperation with the first PE to normalize the result of the multiplication.

42. The processor for parallel operation according to claim 41, wherein the first PE includes:
a multiplier;
a barrel shifter;
a leading-one circuit; and
a general purpose register, wherein,
in executing the multi-cycle floating decimal point multiply instruction,
the multiplier in the first PE multiplies the mantissa parts of operands,
the barrel shifter effects part of normalization of the result of the multiplication, and
the general purpose register is used as a site of temporary storage of the result of the multiplication and an intermediary result of the normalization.

43. The processor for parallel operation according to claim 41, wherein the first PE includes:
an adder;
a barrel shifter;
a general purpose register; and
a normalization controller, and wherein
in executing the multi-cycle floating decimal point multiply instruction,
in the first PE, the adder/subtractor, the barrel shifter and the barrel shifter normalize the result of the multiplication, under control by the normalization controller, and
the general-purpose register is used as a site of temporary storage of an intermediary result of the normalization.

44. The processor for parallel operation according to claim 34, wherein in case an instruction executed by the one group is a multi-cycle floating decimal point divide instruction,
the one group includes a plurality of PEs;
a first one of the PEs in the one group executes division of two floating decimal point operands, and wherein
a second one of the PEs in the one group differing from the first PE counts the number of cycles of execution of the division and normalizes the result of the division.

45. The processor for parallel operation according to claim 44, wherein the first PE includes:
an adder; and
a general purpose register, and wherein
in executing the multi-cycle floating decimal point divide instruction,
in the first PE, a divisor, a dividend and an intermediary result of division are stored in the general purpose register, and
the dividend is subtracted by the adder/subtractor from the divisor to store the result of subtraction in the intermediary result of division.

46. The processor for parallel operation according to claim 44, wherein the second PE includes:
an adder;
a barrel shifter;
a general purpose register; and
a normalization controller, and wherein
in executing the multi-cycle floating decimal point divide instruction,
in the second PE,
the cycle count value is stored in the general purpose register,
the counter value is updated by the adder/subtractor,
the result of division of the first PE is normalized by the adder and the barrel shifter, under control by the normalization controller, and
the general purpose register is used as a temporary site of storage of an intermediary result of the normalization.

47. The processor for parallel operation according to claim 34, wherein operation units of first and second PEs in the one group are connected via an inter-PE operation unit connection path.

48. The processor for parallel operation according to claim 47, wherein the first PE includes:
a control circuit;
a general purpose register set;
an operation unit set; and
a data memory, wherein
an output of the general purpose register set is selected by a selector (mux1-0) controlled by the control circuit, and is supplied as operands (opr0, opr1) of an instruction for operations to the operation unit set and to the data memory, and wherein
the operation unit set includes:
an adder/subtractor;
a multiplier; and
a barrel shifter,
respective operation units of the operation unit set performing operations on operands (opr0, opr1) supplied from the selector (mux1-0) under control by the control circuit,
the result of the operations by the operation unit set being selected by a selector (mux1-1), controlled by the control circuit, so as to be supplied to a selector (mux5),
the data memory writing an output of the selector (mux1-0) and data from an external memory data transfer network in a memory device under control by the control circuit,
data read from the memory device being supplied to the selector (mux5) and to the external memory data transfer network,
the selector (mux5) selecting one of:
the result of selection of the selector (mux1-1),
the read result of the data memory; and
the contents of the register of the second PE provided via the inter-PE operation unit connection path, under control by the control circuit, the selected one being supplied to the general purpose register set.

49. The processor for parallel operation according to claim 48, wherein the second PE includes:
a control circuit;
a general purpose register set;
an operation unit set; and
a data memory, wherein
the operation unit set includes:
an adder/subtractor;
a multiplier; and
a barrel shifter,
an output of the general purpose register set being selected by the selector (mux2-0), controlled by the control circuit, so as to be supplied to the operation unit set and to the data memory;
the second PE further including:
a selector (mux0) that selects one of the result of selection of the selector (mux4) and the result of selection of the selector (mux3), under control by the control circuit, to supply the selected one to the first register (GPL 20) of the register set;
a selector (mux1) that selects one of the selected result of the selector (mux4) and a bit string read from the second register (GPR 21) of the register set from which the LSB (Least Significant Bit) has been removed and to the MSB (Most Significant Bit) of which is added 0, the selector (mux1) supplying the selected one to the second register (GPR 21); and
a selector (mux2) that selects one of the selected result of the selector (mux4) and a bit string read from the third register (GPR 22) of the register set from which the MSB has been removed and to the LSB of which is added the MSB of the result of subtraction of the adder/subtractor, the selector (mux2) supplying the selected one to the second register (GPR 22);
an operation unit of the operation unit set performing an operation on the operands (opr0, opr1) supplied from the selector (mux2-0) under control by the control circuit,
the result of the operation being selected by a selector (mux2-1), controlled by the control circuit, so as to be supplied to the selector (mux4),
the data memory writing an output of the selector (mux2-0) and data from an external memory data transfer network in a memory device and data read from the memory devices being supplied to the selector (mux4) and to the external memory data transfer network,
the selector (mux3) selecting one of the result of the operation of the adder/subtractor and the one operand selected by the selector (mux2-0), under control by the control circuit,
the selector (mux3) supplying the selected one to the selector (mux0),
the selector (mux4) selecting one of the result of selection by the selector (mux2-1) and the read result of the data memory, under control by the control circuit, to supply the selected one to the general purpose register set.

50. The processor for parallel operation according to claim 47, wherein the first PE includes:
a control circuit,
a general purpose register set and
a data memory,
first, second and third registers (GPR 10, GPR 11 and GPR12) of the general purpose register set being updated by the results of selection of selectors (mux00, mux01 and mux02) associated therewith; the remaining registers of the general purpose register set being updated by the result of selection by a selector (mux07),
an output of the general purpose register set being selected by the selector (mux1-0) and supplied as operands (opr0, opr1) to the operation unit set and to the data memory,
the selector (mux00) selecting one of the first operand (fopr1) of a floating decimal point add/subtract instruction supplied from the second PE via the inter-PE operation unit connection path and the result of selection by the selector (mux07), under control by the control circuit, to supply the selected one to the first register (GPR 10),
the selector (mux01) selecting one of the second operand (fopr1) of the floating decimal point add/subtract instruction supplied from the second PE via the inter-PE operation unit connection path and the result of selection by the selector (mux07), under control by the control circuit, to supply the selected one to the second register (GPR 11),
the selector (mux02) selecting one of a bit string, composed of a lower order half of the result of the operation of the differentiator of the operation unit set and a lower order half of the third register (GPR 12) as lower half and upper half, respectively, and the result of selection by the selector (mux07), to supply the selected one to the third register (GPR 12), and wherein
the operation unit set includes:
an adder/subtractor;
a multiplier;
a differentiator, and
a barrel shifter,
the adder/subtractor performing an operation on the result of selection of the selector (mux03) and the operand (opr1), as operands, under control by the control circuit,
the multiplier performing an operation on the operands (opr0, opr1) as operands, under control by the control circuit,
the differentiator performing an operation on the results of selection by the selector (mux04) and the selector (mux05), as operands, under control by the control circuit,
the barrel shifter performing an operation on the operand (opr0) and on the result of selection by the selector (mux06), as operands, under control by the control circuit,
the result of the operation unit set being selected by the selector (mux1-1), controlled by the control circuit, so as to be supplied to the selector (mux07),
the selector (mux03) selecting one of the result of the operation by the barrel shifter and the operand (opr0), under control by the control circuit, to supply the selected one to the adder/subtractor,
the selector (mux04) selecting one of an exponent part (E0) of an operand (fopr0) of a floating decimal point add/subtract instruction as supplied from the second PE via the inter-PE operation unit connection path, and the operand (fopr0), under control by the control circuit, to supply the selected one to the differentiator,
the selector (mux05) selecting one of an exponent part of an operand (fopr1) of a floating decimal point add/subtract instruction as supplied from the second PE via the inter-PE operation unit connection path, under control by the control circuit, to supply the selected one to the differentiator,
the selector (mux06) selecting one of a bit string composed of a lower order half of the register (GPR 12) and 0s stuffed in an upper half thereof, and the operand (opr1), under control by the control circuit, to supply the selected one to the barrel shifter,
the data memory writing data from the general purpose register set and from the external memory data transfer network in a memory device and data read from the memory devices being supplied to the selector (mux07) and to the external memory data transfer network, under control by the control circuit,
the selector (mux07) selecting one of the result of selection by the selector (mux1-1) and the read result of the data memory under control by the control circuit, to supply the result of selection to the general purpose register set.

51. The processor for parallel operation according to claim 50, wherein the second PE includes:
a control circuit;
a general purpose register set;
an operation unit set; and
a data memory;
first, second and third registers (GPR 20, GPR 21) of the general purpose register set being updated by the results of selection of selectors (mux08, mux09); the third register (GPR 22) and the remaining registers being updated by the result of selection by a formatting unit,
an output of the general purpose register set being selected by the selector (mux2-0), controlled by the control circuit, so as to be supplied as operands (opr0, opr1) to the operation unit set and to the data memory,
the selector (mux08) selecting one of a bit string composed of an intermediary result of exponent parts (tmpe) provided by the first PE via the inter-PE operation unit connection path as a lower order part and a result of the sign (sign) as an upper bit, and the result of selection of the selector (mux15), to supply the selected one to the third register (GPR 20),
the selector (mux09) selecting one of the result of the operation of the differentiator of the operation unit set and the result of selection of the selector (mux15), under control by the control circuit, to supply the selected one to the second register (GPR 21) of the general purpose register set, and wherein
the operation unit set includes:
an adder/subtractor,
a multiplier;
a differentiator; and
a barrel shifter;
the adder/subtractor performing an operation on the results of selection of the selector (mux03) and the selector (mux11) as operands, under control by the control circuit,
the multiplier performing an operation on the operands (opr0, opr1), as operands, under control by the control circuit,
the differentiator performing an operation on the results of selection by the selector (mux12) and the selector (mux13), as operands, under control by the control circuit,
the barrel shifter performing an operation on the operand (opr0) and on the result of selection by the selector (mux14), as operands, under control by the control circuit,
the result of the operations of the operation unit set being selected by the selector (mux2-1), controlled by the control circuit, so as to be supplied to the selector (mux15),
the selector (mux10) selecting one of the result of the operation by the barrel shifter and the operand (opr0), under control by the control circuit, to supply the selected one to the adder/subtractor,
the selector (mux11) selecting one of a value 1 and the operand (opr1), under control by the control circuit, to supply the selected one to the adder/subtractor,
the selector (mux12) selecting one of the intermediary result of the mantissa part (tmpf) provided by the first PE via the inter-PE operation unit connection path, and the operand (opr0), under control by the control circuit, to supply the selected one to the differentiator,
the selector (mux13) selecting one of the value 0 and the operand (opr1), under control by the control circuit, to supply the selected one to the differentiator,
the selector (mux14) selecting one of the result of the operation of the leading-one and the operand (opr1) to supply the selected one to the barrel shifter,
the operation unit set including a leading-one, an adder and a rounding detection unit, used exclusively for execution of a floating decimal point add/subtract instruction,
the leading-one retrieving the bit string of the operand (opr0) from an MSB side to calculate the distance from the MSB to the first appearance of 1 to supply the distance calculated to the adder and the selector (mux14),
the adder summing a partial bit string of the operand (opr1) to the retrieved result of the leading-one to supply the result of the addition to the formatting unit,
the rounding detection unit deciding whether or not the result of the operations by the barrel shifter is in need of rounding, and supplying the result of the decision to the selector (mux2-1),
the data memory writing data from the general purpose register set and from the external memory data transfer network in a memory device and data read from the memory devices being supplied to the selector (mux15) and to the external memory data transfer network, under control by the control circuit,
the selector (mux15) selecting one of the result of selection by the selector (mux2-1) and the read result of the data memory, under control by the control circuit, to supply the selected one to the formatting unit,
the formatting unit selecting the result of selection by the selector (mux15) as a mantissa part, selecting the result of the operation by the adder/subtractor as an exponent part and selecting the result of the sign (sign) as a sign part, under control by the control circuit; the formatting unit setting the form and providing the resulting form to the general purpose register set.

52. The processor for parallel operation according to claim 47, wherein the first PE includes:
a control circuit;
a general purpose register set;
an operation unit set and
a data memory, wherein
the general purpose register set includes
a plurality of registers (GPR 10˜GPR 1p),
the register (GPR 12) being updated by the results of selection of the selector (mux00),
the remaining registers (GPR 10 and GPR 11) and (GPR 13 and GPR 1p) being updated by the result of selection by a selector (mux07),
an output of the general purpose register set being selected by the selector (mux1-0) controlled by the control circuit and supplied as operands (opr0, opr1) to the operation unit set and to the data memory,
the selector (mux00) selecting one of the result of selection of the adder/subtractor and the result of selection of the selector (mux07) to provide the selected one to the register (GPR 12), and wherein
the operation unit set includes:
an adder/subtractor;
a multiplier; and
a barrel shifter,
the adder/subtractor performing operations on the result of selection of the selector (mux01) and the result of selection of the selector (mux02) as operands, under control by the control circuit,
the multiplier performing operations on the result of selection of the selector (mux03) and the result of selection of the selector (mux04) as operands, under control by the control circuit,
the barrel shifter performing operations on the results of selection by the selector (mux05) and (mux06), as operands, under control by the control circuit,
the result of the operation being selected by the selector (mux1-1) controlled by the control circuit so as to be supplied to the selector (mux07),
the selector (mux01) selecting one of a bit string composed of an exponent part of the operand (opr0) as lower order bits and 0s combined in an upper order side, and the operand (opr0), under control by the control circuit, to supply the selected one to the adder/subtractor,
the selector (mux02) selecting one of a bit string composed of an exponent part of the operand (opr1) as lower order bits and 0s combined in an upper order side, and the operand (opr1), under control by the control circuit, to supply the selected one to the adder/subtractor,
the selector (mux03) selecting one of a bit string composed of a single precision mantissa part of the operand (opr0) as lower order bits, 1 as an upper order bit and 0s combined in a further upper side, and the operand (opr0), under control by the control circuit, to supply the selected one to the multiplier,
the selector (mux04) selecting one of a bit string composed of a single precision mantissa part of the operand (opr1) as lower order bits, 1 as an upper order bit and 0s combined in an upper side, and the operand (opr1), under control by the control circuit, to supply the selected one to the multiplier,
the selector (mux05) selecting one of a bit string composed of upper order bits of the bit string (tmpf) and 0s combined in an upper side thereof, and the operand (opr0), to supply the selected one to the barrel shifter,
the bit string (tmpf) being composed of lower order bits of the register (GRP1p-1) as upper order bits and preset bits of the register (GRP 1p) as lower order bits,
the selector (mux06) selecting one of the result of the operation of the leading-one and the operand (opr1) to supply the selected one to the barrel shifter,
the operation unit set including the leading-one used exclusively for execution of a floating decimal point add/subtract instruction, and an adder,
the leading-one retrieving the bit string of the intermediary result of the mantissa part from an MSB side to calculate the distance from the MSB to the first appearance of 1 to supply the distance calculated to the adder, the selector (mux06) and to the second PE,
the adder summing a intermediary result of the mantissa part (tmpe0) stored in the register (GRP 12) and the retrieved result of the leading-one to each other to provide the result of the addition to the second PE,
the data memory writing data from the general purpose register set and from the external memory data transfer network in a memory device and data read from the memory device being supplied to the selector (mux07) and to the external memory data transfer network, under control by the control circuit,
the selector (mux07) selecting one of the result of selection by the selector (mux1-1) and the read result of the data memory, under control by the control circuit, to supply the result of selection to the general purpose register set.

53. The processor for parallel operation according to claim 47, wherein the second PE receives from the first PE, via the inter-PE operation unit connection path, an intermediary result of the mantissa part (tmpf), an exponent intermediary result (tmpe1), a sign result (sign) and upper data (hdata) of intermediary shift result, as intermediary results of a multi-cycle floating decimal point multiply instruction; the second PE providing lower data (ldata) of the intermediary shift result to the first PE.

54. The processor for parallel operation according to claim 52, wherein the second PE includes:
a control circuit;
a general purpose register set;
an operation unit set; and
a data memory, wherein
the general purpose register set includes
a plurality of registers (GPR 20˜GPR2p),
the registers (GPR 20˜GPR2p) being updated by the result of selection by the formatting unit,
an output of the general purpose register set being selected by the selector (mux2-0), controlled by the control circuit, so as to be supplied to the operation unit set and to the data memory, and wherein
the operation unit set includes:
an adder/subtractor;
a multiplier; and
a barrel shifter,
the adder/subtractor performing operations on the results of selection by the selectors (mux08) and (mux09) as operands, under control by the control circuit,
the multiplier performing an operation on the opr0 and opr1 as operands, under control by the control circuit,
the barrel shifter performing an operation on the result of selection by the selectors (mux10) and (mux11) as operands, under control by the control circuit;
the results of the operations by the operation unit set being selected by the selector (mux2-1), controlled by the control circuit, so as to be supplied to the selector (mux12);
the selector (mux08) selecting one of the result of the operation by the barrel shifter and the operand (opr0), under control by the control circuit, and supplying the selected one to the adder/subtractor;
the selector (mux09) selecting one of the value 1 and the operand (opr1), under control by the control circuit, and supplying the selected one to the adder/subtractor,
the selector (mux10) selecting lower order bits of the intermediary result of the mantissa part (tmpf) as intermediary result of a floating decimal point multiply instruction, or the operand (opr0), under control by the control circuit, to supply the selected one to the barrel shifter,
the selector (mux11) selecting one of the shift width provided by the first PE and the operand (opr1), provided from the PE-1 via the inter-PE operation unit connection path, under control by the control circuit, to supply the selected one to the barrel shifter,
the operation unit set further including a subtractor and a rounding detection unit, used exclusively for executing a floating decimal point subtract instruction;
the subtractor subtracting a preset value from the exponent intermediary result (tmpe1) to supply the result of the subtraction to the formatting unit,
the rounding detection unit checking to see if the result of the operations of the barrel shifter is in need of rounding; the rounding detection unit supplying the result of the check to the selector (mux2-1),
the data memory writing data from the general purpose register set and from the external memory data transfer network in a memory device and data read from the memory devices being supplied to the selector (mux12) and to the external memory data transfer network, under control by the control circuit,
the selector (mux12) selecting one of the result of selection by the selector (mux2-1) and the read result of the data memory, under control by the control circuit, to supply the selected one to the formatting unit,
the formatting unit selecting one of the result of selection by the selector (mux12), the result of the operation by the subtractor and the result of the sign (sign) supplied by the first PE, under control by the control circuit, to supply the selected one to the general purpose register set,
the formatting unit selecting the result of selection by the selector (mux12), as a mantissa part, selecting the result of the operation by the subtractor as an exponent part, selecting the result of the sign (sign) supplied by the first PE as sign, setting the form in order and providing the resulting form to the general purpose register set.

55. The processor for parallel operation according to claim 47, wherein the first PE receives from the second PE, via the inter-PE operation unit connection path, an end signal of the multi-cycle floating decimal point instruction, and sends to the second PE a sign of the result of the operation (sign), an exponent intermediary result (tmpe) and one digit of the result of the operation (QUO).

56. The processor for parallel operation according to claim 47, wherein the first PE includes:
a control circuit;
a general purpose register set;
an operation unit set; and
a data memory; wherein
the general purpose register set includes
a plurality of registers (GPR10˜GPR1p),
the registers (GPR 10, GPR 11, GPR 12) being updated by the results of selection of the associated selectors (mux00, mux01, mux02),
the remaining registers (GPR 13˜GPR 1p) being updated by the result of selection by the selector (mux04),
an output of the general purpose register set being selected by the selector (mux1-0), controlled by the control circuit, so as to be supplied as operands (opr0, opr1) to the operation unit set and to the data memory,
the selector (mux00) selecting one of a bit string composed of a mantissa part of the register (GPR10), whose upper bit is set to 1, and a 0 on a further upper side, the result of selection of the selector (mux03) and the result of the selection of the selector (mux04), under control by the control circuit, to supply the selected one to the register (GPR 10),
the selector (mux01) selecting one of a bit string composed of a mantissa part of the register (GPR 11), whose upper order bit is set to 1, and 0s combined in a further upper order side, and the result of the selection by the selector (mux04), to supply the selected one to the register (GPR 11),
the selector (mux0) selecting one of the result of the subtraction of the subtractor of the operation unit set and the result of the selection of the selector (mux04) to provide the selected one to the register (GPR 11), wherein
the general purpose register set includes
a subtractor used exclusively for execution of a floating decimal point multiply instruction,
the subtractor subtracting an exponent part of the register (GPR 11) from the exponent part of the register (GPR 10) to supply the result of the subtraction to the selector (mux02), and wherein
the operation unit set includes:
an adder/subtractor;
a multiplier; and
a barrel shifter,
respective operation units of the operation unit set performing operations on the operands (opr0, opr1) supplied from the selector (mux1-0) under control by the control circuit,
the results of operations by the operation unit set are selected by the selector (mux1-1), controlled by the control circuit, so as to be supplied to the selector (mux04),
the data memory writing data from the general purpose register set and from the external memory data transfer network in a memory device and data read from the memory devices being supplied to the selector (mux04) and to the external memory data transfer network, under control by the control circuit,
the selector (mux04) selecting one of the result of selection by the selector (mux1-1) and the read result of the data memory, under control by the control circuit, to supply the result of selection to the general purpose register set.

57. The processor for parallel operation according to claim 47, wherein the second PE receives from the first PE, via the inter-PE operation unit connection path, one digit of the result of the operations (QUO), an exponent intermediary result (Wipe) representing an intermediary result of a floating decimal point instruction, and a sign result (sign); the second PE providing an end signal (END) of the multi-cycle floating decimal point operation to the first PE.

58. The processor for parallel operation according to claim 56, wherein the second PE includes:
a control circuit;
a general purpose register set;
an operation unit set; and
a data memory, wherein
the general purpose register set includes
a plurality of registers (GPR 20˜GPR 2p),
the register (GPR 20) being updated by the result of selection by the selector (mux05),
the remaining registers (GPR 21˜GPR 2p) being updated by the result of selection by the formatting unit,
an output of the general purpose register set being selected by the selector (mux2-0), controlled by the control circuit, so as to be supplied as operands (opr0, opr1) to the operation unit set and to the data memory,
the selector (mux05) selecting one of a bit string composed of the register (GPR 20), whose MSB is removed and to the LSB of which is added one result digit (QUO) of the floating decimal point instruction supplied via the inter-PE operation unit connection path from the first PE, and the result of selection of the formatting unit, and supplying the selected one to the register (GPR 20), and wherein
the operation unit set includes:
an adder/subtractor;
a multiplier; and
a barrel shifter,
the adder/subtractor performing an operation on the result of selection by the selector (mux06) and the operand (opr1), as operands, under control by the control circuit,
the multiplier performing an operation on the operands (opr0, opr1), under control by the control circuit,
the barrel shifter performing operations on the operand (opr0) and on results of selection of the selector (mux07) under control by the control circuit, the result of the operations being selected by the selector (mux2-1), controlled by the control circuit, so as to be supplied to the selector (mux08),
the selector (mux06) selecting one of the result of the operation of the barrel shifter and the operand (opr0), under control by the control circuit, to provide the result of the selection to the adder/subtractor,
the selector (mux07) selecting one of the result of the operation of the leading-one and the operand (opr1), under control by the control circuit, to supply the selected one to the barrel shifter,
the operation unit set including a leading-one, an adder and a rounding detection unit used exclusively for execution of a floating decimal point add/subtract instruction,
the leading-one retrieving the bit string of the operand (opr0) from an MSB side towards the LSB side to calculate the distance from the MSB to the first appearance of 1 to supply the distance calculated to the adder and to the selector (mux07),
the adder summing an exponent intermediary result (tmp) supplied via the inter-PE operation unit connection path from the first PE to the result of the operation of the leading-one to provide the result of the addition to the formatting unit,
the rounding detection unit checking to see whether the result of the operation of the barrel shifter is in need of rounding and supplying the result of check to the selector (mux2-1),
the data memory writing data from the general purpose register set and from the external memory data transfer network in a memory device and data read from the memory devices being supplied to the selector (mux08) and to the external memory data transfer network, under control by the control circuit,
the selector (mux08) selecting one of the result of selection by the selector (mux2-1) and the read result of the data memory, under control by the control circuit, to supply the result selected to the general purpose register set,
the formatting unit selecting one of the result of selection by the selector (mux08), the result of addition by the adder and the sign result (sign) supplied from the first PE, under control by the control circuit, to supply the selected result to the general purpose register set,
the formatting unit selecting the result of selection by the selector (mux08) as a mantissa part, selecting the result of the operation by the adder as an exponent part and selecting the result of the sign (sign) supplied by the first PE as a sign part,
the formatting unit setting the form in order and providing the resulting form to the general purpose register set.

59. The processor for parallel operation according to claim 34, wherein the information regarding the configuration of the PE that composes the group is pre-retained in accordance with the instruction, and wherein
the configuration of the PE is varied, based on the information, in accordance with the instruction.

60. The processor for parallel operation according to claim 59, wherein in case
the instruction is a multi-cycle instruction executed in a plurality of cycles of the PEs, the description of the configuration of pipelining registers is provided in the information.

61. A method for controlling instruction execution by a reconfigurable processor for parallel operation including a plurality of processing elements (PEs), the method comprising:
making a unit of operation executing an instruction correspond to one group;
the one group that includes a plurality of processing elements (PEs) implementing at least a part of an operation unit that executes at least one of:
an integer divide instruction;
a floating decimal point add/subtract instruction;
a floating decimal point multiply instruction; and
a floating decimal point divide instruction, using operation units and general purpose registers provided in a plurality of the PEs; and
varying the number of the PEs that compose the one group in accordance with the instruction.

62. The method for controlling instruction execution according to claim 61, comprising:
pre-retaining the information regarding the configuration of the PE that composes the group in accordance with the instruction, and varying the configuration of the PE, based on the information, in accordance with the instruction.

63. The method for controlling instruction execution according to claim 61, comprising
in executing at least one of the integer divide instruction, floating decimal point add/subtract instruction, floating decimal point multiply instruction and the floating decimal point divide instruction, utilizing an operation unit and/or a general-purpose register provided in each of the PEs as at least a part of the operation units and/or pipelining registers that execute the instruction.
